(19) United States
(12) Patent Application Publication
(10) Pub. No.: US 2019/0237731 A1
(43) Pub. Date: Aug. 1, 2019

(54) POROUS FILM, SEPARATOR INCLUDING POROUS FILM, ELECTROCHEMICAL DEVICE INCLUDING POROUS FILM, AND METHOD OF PREPARING POROUS FILM

(71) Applicant: Samsung Electronics Co., Ltd., Suwon-si (KR)

(72) Inventors: Kitae Park, Seoul (KR); Jinkyu Kang, Hwaseong-si (KR); Nagjong Kim, Suwon-si (KR); Sunghaeng Lee, Seoul (KR)

(21) Appl. No.: 16/265,619

(22) Filed: Feb. 1, 2019

(30) Foreign Application Priority Data
Feb. 1, 2018 (KR) 10-2018-0013085

(51) Int. Cl. H01M 2/16; H01M 2/14; H01M 10/0525; H01G 11/52

(52) U.S. Cl. CPC H01M 2/1626; H01M 2/145; H01G 11/52; H01M 10/0525; H01M 2/1686

(57) ABSTRACT

A porous film, a separator including the porous film, an electrochemical device including the porous film, and a method of preparing the porous film are provided, wherein the porous film includes: small-diameter fibers having an average diameter of about 50 nm or less; and large-diameter fibers having an average diameter of about 100 nm or greater, wherein an amount of the large-diameter fibers is about 5 wt % to about 60 wt % based on a total weight of the small-diameter fibers and the large-diameter fibers.

### CROSS-REFERENCE TO RELATED APPLICATION

This application claims the benefit of Korean Patent Application No. 10-2018-0013085, filed on Feb. 1, 2018, in the Korean Intellectual Property Office, the entire disclosure of which is hereby incorporated by reference.

### BACKGROUND

### 1. Field

The present disclosure relates to a porous film, a separator including the porous film, an electrochemical device including the porous film, and a method of preparing the porous film.

2. Description of the Related Art

Electrochemical cells such as lithium secondary batteries use a separator that prevents a short circuit by separating a positive electrode and a negative electrode. The separator needs to be tolerant to a liquid electrolyte and have low internal resistance.

In recent years, demand for electrochemical cells having high thermal resistance has increased due to use of electrochemical cells in vehicles. Polyolefin-based porous films including polyethylene or polypropylene have been used as separators in lithium secondary batteries. However, a battery for vehicles is required to have high thermal resistance at a temperature of about 150° C. or higher, and thus it is not possible to apply the polyolefin-based separator to such a battery for vehicles.

A porous film comprising cellulose has high thermal resistance and may be suitable for use as a separator for vehicle batteries. However, as the space between cellulose fibers in such a porous film becomes smaller, the pore size of the porous film decreases. Consequently, the porous film may have increased internal resistance, which adversely affects the power output of a lithium battery.

Therefore, there is a need for a porous film that provides improved power output.

### SUMMARY

Provided herein is a porous film that includes: small-diameter fibers having an average diameter of about 50 nm or less; and large-diameter fibers having an average diameter of about 100 nm or greater, wherein an amount of the large-diameter fibers is about 5 wt % to about 60 wt % based on a total weight of the small-diameter fibers and the large-diameter fibers.

Also provided is a separator that includes the above-described porous film.

Another aspect of the disclosure provides an electrochemical device that includes: a positive electrode; a negative electrode; and the above-described separator between the positive electrode and the negative electrode.

Further provided is a method of preparing a porous film, wherein the method comprises: preparing a composition comprising large-diameter fibers having an average diameter of about 100 nm or greater, small-diameter fibers having an average diameter of about 50 nm or less, a hydrophilic pore-forming agent, and a solvent, and applying the composition onto a substrate; drying the composition to thereby form a sheet on the substrate; and separating the sheet from the substrate to thereby obtain the porous film.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1A is a transmission electron microscope (TEM) image of a porous film as described in Example 1;

FIG. 1B is a graph detailing the number of cellulose nanofibers in the porous film having a particular diameter, as described in Example 1, obtained using an image analyzer;

FIGS. 2A-2H are cross-sectional views of porous films according to certain embodiments; and

FIG. 3 is a schematic view of a lithium battery comprising the porous film, according to one embodiment.

### DETAILED DESCRIPTION

As the present inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope of the present inventive concept are encompassed by the present inventive concept.

The terms used in the present specification are merely used to describe particular embodiments, and are not intended to limit the present inventive concept. An expression used in the singular encompasses the expression of the plural, unless it has a clearly different meaning in the context. In the present specification, it is to be understood that terms such as “including,” “having,” “comprising,” etc., are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added. As used herein, the term “and/or” includes any and all combinations of one or more of the associated listed items. Expressions such as “at least one of,” when preceding a list of elements, modify the entire list of elements and do not modify the individual elements of the list.

In the drawings, the thicknesses of layers and regions are not necessarily drawn to scale and may be exaggerated or reduced for clarity. Like reference numerals in the drawings and specification denote like elements. In the present specification, it will be understood that when an element, e.g., a layer, a film, a region, or a substrate, is referred to as being “on” or “above” another element, such element can be directly on the other element, or intervening layers may separate the elements. While such terms as “first,” “second,” etc., may be used to describe various components, such components must not be limited to the above terms. The above terms are used only to distinguish one component from another.

Hereinafter, according to illustrative embodiments, a porous film, a separator comprising the porous film, an electrochemical device comprising the porous film or separator, and a method of preparing the porous film will be described in further detail.

In accordance with one embodiment of the disclosure, a porous film comprises: small-diameter fibers having an average diameter of about 50 nm or less; and large-diameter fibers having an average diameter of about 100 nm or greater, wherein an amount of the large-diameter fibers is about 5 wt % to about 60 wt % based on a total weight of the small-diameter fibers and the large-diameter fibers combined.

This combination of the small-diameter fibers and the large-diameter fibers may improve mechanical properties and air permeability. However, when the large-diameter fibers have an average diameter smaller than 100 nm, and/or the small-diameter fibers have an average diameter larger than 50 nm, the difference in diameter between the small-diameter fibers and the large-diameter fibers may be as small as less than 50 nm, which may lead to decreased air permeability in the porous film.

When the amount (e.g., wt %) of the large-diameter fibers is within the range of about 5 wt % to about 60 wt % based on a total weight of the small-diameter fibers and the large-diameter fibers, the porous film may have improved mechanical properties and air permeability. When the amount of the large-diameter fibers is too small, any improvement in air permeability may be insignificant. When the amount of the large-diameter fibers is too large, mechanical properties of the porous film may be deteriorated. Due to the improved mechanical properties of the porous film, the porous film may be implemented with a small thickness, and a lithium battery may have improved energy density and power output by including such a thin porous film containing the small-diameter fibers and the large-diameter fibers. In some embodiments, the amount of the large-diameter fibers in the porous film may be about 5 wt % to about 60 wt %, about 5 wt % to about 55 wt %, about 5 wt % to about 50 wt %, about 5 wt % to about 45 wt %, about 5 wt % to about 40 wt %, about 5 wt % to about 35 wt %, about 5 wt % to about 30 wt %, about 5 wt % to about 25 wt %, about 5 wt % to about 20 wt %, about 5 wt % to about 15 wt %, or about 5 wt % to about 10 wt %, based on a total weight of the small-diameter fibers and the large-diameter fibers.

As used herein, the term “average diameter” of the large-diameter fibers and the small-diameter fibers refers to an average of the diameters of 100 fibers arithmetically calculated by analyzing transmission electron microscope (TEM) images of the fibers using an image analyzer.

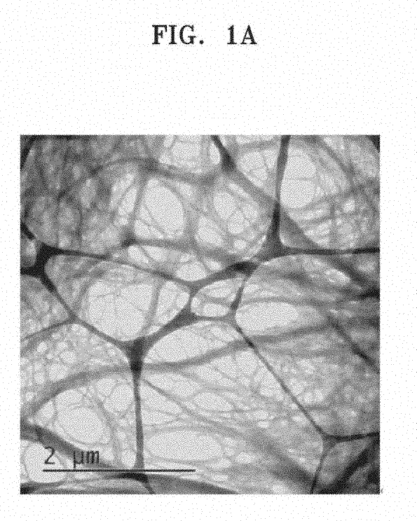

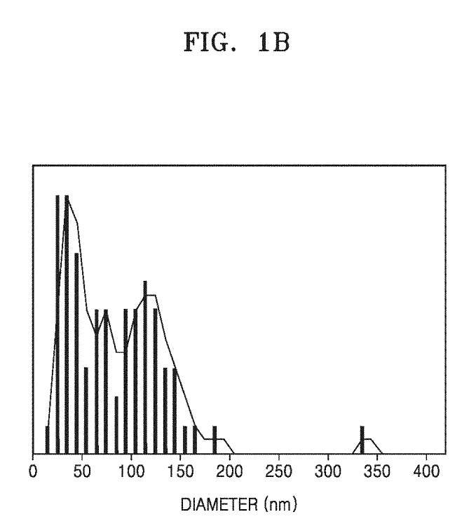

In one or more embodiments, the porous film may have a multi-modal fiber diameter distribution curve. For instance, the porous film may have a bimodal fiber diameter distribution curve including two peaks with respect to fiber diameters. Referring to FIG. 1B, a porous film according to an embodiment may include a first peak at about 50 nm or less derived from the small-diameter fibers and a second peak at about 100 nm derived from the large-diameter fibers. Due to the inclusion of the fibers having a bimodal fiber diameter distribution with two peaks, the porous film according to the one or more embodiments may have improved mechanical properties and/or air permeability compared to conventional porous films, which generally include fibers having a diameter distribution with a single peak.

In one or more embodiments, the porous film may be a porous film that is a product of binding or twisting of the fibers, resulting from drying a composition comprising the large-diameter fibers and the small-diameter fibers. A conventional non-woven web-type porous film is generally formed by a non-solvent method or electrospinning method from a composition comprising a dissolved polymer resin in a non-fibrous state. Thus, the structure of the porous film according to the one or more embodiments of the present disclosure may be different from such a non-woven web-type porous film. According to additional embodiments, the structure of the porous film may be that of a non-woven fabric.

The Gurley value is a time (sec) value at which 100 cc of air permeates a porous film and is a standard commonly used in quantitative analysis of a pore structure of a porous film. The porous film may have a Gurley value per unit thickness of, for example, about 30 sec/100 cc·μm or less, about 28 sec/100 cc·μm or less, about 26 sec/100 cc·μm or less, about 24 sec/100 cc·μm or less, about 22 sec/100 cc·μm or less, about 20 sec/100 cc·μm or less, about 18 sec/100 cc·μm or less, about 16 sec/100 cc·μm or less, about 14 sec/100 cc·μm or less, about 12 sec/100 cc·μm or less, or about 10 sec/100 cc·μm or less. For example, a Gurley value per unit thickness of the porous film, which corresponds to the air permeability per unit thickness, may be about 5 sec/100 cc·μm or greater, about 6 sec/100 cc·μm or greater, about 7 sec/100 cc·μm or greater, or about 8 sec/100 cc·μm or greater. Measurement of the Gurley value may be performed according to Evaluation Example 3, which will be described later. The Gurley value per unit thickness of the porous film may be measured using a method according to Japanese Industrial Standards (JIS) P8117.

In one or more embodiments, the porous film may have a thickness of, for example, about 10 μm or greater. For example, the porous film may have a thickness of about 10 μm to about 500 μm, about 10 μm to about 450 μm, about 10 μm to about 400 μm, about 10 μm to about 350 μm, about 10 μm to about 300 μm, about 10 μm to about 250 μm, about 10 μm to about 200 μm, about 10 μm to about 150 μm, about 10 μm to about 100 μm, about 10 μm to about 80 μm, about 10 μm to about 60 μm, about 10 μm to about 40 μm, or about 10 μm to about 30 μm. For example, the porous film may have a thickness of about 10 μm to about 30 μm. The thickness of the porous film may be measured according to the method referenced in Evaluation Example 3 set forth herein. When the thickness of the porous film is too thin, mechanical properties of the porous film may be deteriorated, and the porous film may be broken when assembled as a separator into a lithium battery, or during charging and discharging of the lithium battery due to the formation of dendrites, thereby causing deterioration of the lithium battery. When the porous film is too thick, a lithium battery using the porous film as a separator may have increased internal resistance, deteriorated cycle characteristics, and reduced energy density per unit volume. Accordingly, the smaller the thickness of the porous film becomes, the smaller the thickness of a lithium battery comprising the porous film may become, and the energy density per unit volume of the lithium battery may be improved.

The porous film may have an air permeability as a Gurley value of, for example, about 50 sec/100 cc to about 800 sec/100 cc, about 50 sec/100 cc to about 750 sec/100 cc, about 50 sec/100 cc to about 700 sec/100 cc, about 50 sec/100 cc to about 650 sec/100 cc, about 50 sec/100 cc to about 600 sec/100 cc, about 50 sec/100 cc to about 550 sec/100 cc, about 50 sec/100 cc to about 500 sec/100 cc, about 50 sec/100 cc to about 450 sec/100 cc, about 50 sec/100 cc to about 400 sec/100 cc, about 50 sec/100 cc to about 350 sec/100 cc, or about 50 sec/100 cc to about 300 sec/100 cc. The Gurley value may be measured using a method according to Japanese Industrial Standards (JIS) P8117. When the Gurley value is too low, lithium may easily precipitate in pores of the porous film. Accordingly, when a porous film having an excessively low Gurley value is used as a separator in a lithium battery, a short circuit caused by lithium dendrites is more likely to occur due to poor lithium blocking characteristics of the separator. On the other hand, when the Gurley value is too high, migration of lithium ions through the porous film may be hindered. Accordingly, when a porous film having an excessively high Gurley value is used as a separator in a lithium battery, cycle characteristics of the lithium battery may be deteriorated due to increased internal resistance of the lithium battery.

In some embodiments, the porous film may have a uniform Gurley value over the entire region of the porous film. When the porous film has uniform air permeability, a lithium battery including the porous film as a separator may have a uniformly distributed current density in an electrolyte, such that a side reaction, like precipitation of crystals at an interface between an electrode and the electrolyte, may be inhibited.

The porous film according to one or more embodiments may have a porosity of, for example, about 10% to about 90%, about 15% to about 85%, about 20% to about 80%, about 25% to about 80%, about 30% to about 80%, about 35% to about 80%, about 35% to about 75%, or about 40% to about 75%. An electrochemical device may operate even with a porosity of less than 10%. However, such a low porosity may result in increased internal resistance and a low output, thus deteriorating performance of the electrochemical device. When the porosity is greater than 90%, there is low internal resistance, such that an electrochemical device may have improved output characteristics. For example, a lithium battery may have improved cycle characteristics. However, a short circuit is more likely to occur due to lithium dendrites, consequently leading to deteriorated safety. The porosity of the porous film may be measured using a liquid or gas absorption method according to ASTM D-2873.

The porous film according to one or more embodiments may have a tensile strength of, for example, about 500 kgf/cm² or greater, about 550 kgf/cm² or greater, about 600 kgf/cm² or greater, about 650 kgf/cm² or greater, about 700 kgf/cm² or greater, about 750 kgf/cm² or greater, about 800 kgf/cm² or greater, about 850 kgf/cm² or greater, about 900 kgf/cm² or greater, or about 950kgf/cm² or greater. For example, the porous film may have a tensile strength of about 500 kgf/cm² to about 1000 kgf/cm², about 500 kgf/cm² to about 950 kgf/cm², about 500 kgf/cm² to about 900 kgf/cm², about 500 kgf/cm² to about 850 kgf/cm², about 500 kgf/cm² to about 800 kgf/cm², about 500 kgf/cm² to about 750 kgf/cm², or about 500 kgf/cm² to about 700 kgf/cm². When the porous film has a tensile strength within these ranges, the porous film may satisfy a minimum tensile strength requirement for manufacturing a winding-type battery, and a pin-puncture strength may be further improved. Accordingly, when the porous film according to the one or more embodiments is used as a separator of a lithium battery, the separator may have increased durability during charging and discharging of the lithium battery and provide further increased battery capacity due to a reduced thickness of the separator. Contrarily, when the porous film has a tensile strength of less than 500 kgf/cm², the separator may have reduced durability and a reduced manufacturing yield due to damage incurred during assembly of a battery, making it impossible to manufacture a winding-type battery with the separator. This low tensile strength may also lead to reduced durability with a weak pin-puncture strength, an increased separator thickness required to ensure a minimum tension, and consequently, a reduced battery capacity. The tensile strength of the porous film may be measured according to method referenced in Evaluation Example 1 set forth herein.

The porous film according to one or more embodiments may have a pin-puncture strength of, for example, about 70 kgf or greater, about 75 kgf or greater, about 80 kgf or greater, about 85 kgf or greater, about 90 kgf or greater, about 95 kgf or greater, or about 100 kgf or greater. For example, the porous film may have a pin-puncture strength of about 70 kgf to about 150 kgf, about 75 kgf to about 150 kgf, about 80 kgf to about 150 kgf, about 80 kgf to about 145 kgf, about 85 kgf to about 140 kgf, about 90 kgf to about 140 kgf, or about 90 kgf to about 130 kgf. When the porous film has a pin-puncture strength within these ranges, it may be possible to effectively suppress a short circuit caused from dendritic formation during charging and discharging. Accordingly, when such a porous film according to one or embodiments is used as a separator of a lithium battery, the separator may have increased durability during charging and discharging of the lithium battery, thereby suppressing deterioration of the lithium battery and leading to further increased battery capacity due to a reduced thickness of the separator. When the porous film has a pin-puncture strength of less than 70 kgf, the separator may have reduced durability, which leads to reduced battery capacity due to an increased separator thickness required to ensure a minimum pin-puncture strength. The pin-puncture strength of the porous film may be measured according to the method referenced in Evaluation Example 2 set forth herein.

Due to the inclusion of the large-diameter fibers in the porous film, relatively large-diameter pores may be introduced in the porous film near the large-diameter fibers, consequentially increasing air permeability of the porous film. In some embodiments, the large-diameter fibers of the porous film may have an average diameter of about 100 nm or greater, about 200 nm or greater, about 400 nm or greater, about 600 nm or greater, about 800 nm or greater, about 1 μm or greater, about 2 μm or greater, about 4 μm or greater, about 6 μm or greater, about 8 μm or greater, or about 10 μm or greater. For example, the large-diameter fibers may have an average diameter of about 100 nm to about 20 μm, about 100 nm to about 15 μm, about 100 nm to about 10 μm, about 100 nm to about 8 μm, about 100 nm to about 6 μm, about 100 nm to about 5 μm, about 100 nm to about 4 μm, about 100 nm to about 3 μm, or about 100 nm to about 2 μm. When the large-diameter fibers of the porous film have an average diameter within these ranges, the porous film may retain or improve mechanical properties and have increased air permeability.

The large-diameter fibers of the porous film may include, for example, at least one selected from cellulose fibers and heat-resistant polymer fibers.

The large-diameter cellulose fibers may include, for example, natural cellulose, such as plant cellulose fibers, animal cellulose fibers, and/or microbial cellulose fibers. The cellulose fibers may be, for example, wood pulp such as needle-leaved tree pulp or broad-leaved tree pulp; cotton pulp such as cotton linter; non-wood pulp such as straw pulp or bagasse pulp; bacterial cellulose; or cellulose separated from Ascidiacea or seaweed. In some embodiments, the large-diameter cellulose fibers include wood cellulose nanofibers originating from wood pulp. In some embodiments, the large-diameter cellulose fibers include animal cellulose nanofibers originating from tunicate such as sea pineapple. The large-diameter fibers may include cellulose nanofibers having an average diameter of 100 nm or greater. Due to the excellent thermal resistance of cellulose fibers, the porous film including the large-diameter cellulose fibers may have improved thermal resistance.

The heat-resistant polymer fibers may include fibers comprising at least one selected from a polysulfone (PSF) polymer, a polyether sulfone (PES) polymer, a polyetherimide (PEI) polymer, a polyphenylene sulfide (PPS) polymer, a polyetheretherketone (PEEK) polymer, a polyarylate (PA) polymer, a polyamide-imide (PAI) polymer, a polyimide (PI) polymer, a polyamide polymer, and an aramid polymer, or may include a mixture or copolymer thereof. The heat-resistant polymer may have a molecular weight of, for example, about 10,000 Daltons or greater, about 50,000 Daltons or greater, about 100,000 Daltons or grater, or about 500,000 Daltons or greater. The molecular weight of the heat-resistant polymer may be measured, for example, using gel permeation chromatography (GPC) with a polyethylene standard sample. Due to the inclusion of the heat-resistant polymer, the porous film may have improved thermal resistance.

In some embodiments, the heat-resistant polymer fibers may include at least one selected from polyethylene terephthalate (PET) fibers, polyacrylonitrile (PAN) fibers, polyvinylidene fluoride (PVDF) fibers, nylon fibers, and aramid fibers; or a mixture or copolymer thereof.

The small-diameter fibers of the porous film may have a high aspect ratio. The aspect ratio refers to a ratio of length to diameter of the small-diameter fibers. For example, the small-diameter fibers may have an aspect ratio of about 10 or greater, about 20 or greater, about 40 or greater, about 50 or greater, or about 100 or greater. Due to the inclusion of the small-diameter fibers having a high aspect ratio, the small-diameter fibers may have improved binding strength therebetween, and thus, the porous film may have improved mechanical properties. In some embodiments, the small-diameter cellulose nanofibers may have an average diameter of, for example, about 50 nm or less, about 45 nm or less, about 40 nm or less, about 35 nm or less, about 30 nm or less, or about 25 nm or less. The small diameter cellulose nanofibers of the porous film may have an average diameter of, for example, about 1 nm to about 50 nm, about 1 nm to about 45 nm, about 1 nm to about 40 nm, about 1 nm to about 35 nm, about 1 nm to about 30 nm, or about 1 nm to about 25 nm. In some embodiments, in a diameter distribution curve of the small diameter fibers such as disclosed in FIG. 1B, a full width at half maximum (FWHM) of a diameter peak may be, for example, about 50 nm or less, about 45 nm or less, about 40 nm or less, about 35 nm or less, about 30 nm or less, about 25 nm or less, about 20 nm or less, about 15 nm or less, or about 10 nm or less. A FWHM of a diameter peak in a diameter distribution curve may be, for example, about 1 nm to about 45 nm, about 5 nm to about 45 nm, or about 10 nm to about 45 nm. When the porous film includes nanofibers having a narrow FWHM within any of these ranges, the porous film may have improved uniformity (i.e., a uniform Gurley value over the entire region of the porous film), and further improved tensile strength due to increased contact points between fibers.

The small-diameter fibers may have a high degree of crystallinity. For example, the small-diameter fibers may have a degree of crystallinity of about 80% or greater, about 85% or greater, about 90% or greater, about 95% or greater, or about 99% or greater. The degree of crystallinity (DOC) of the small-diameter fibers may be determined from a ratio of the heat of fusion calculated from the area of a phase transition peak of the fibers obtained by differential scanning calorimetry (DSC), to the heat of fusion of fibers having 100% crystallinity.

The small-diameter fibers may comprise cellulose fibers. For example, the second cellulose fibers may be cellulose nanofibers having an average diameter of about 50 nm or less. The cellulose fibers may be, for example, carboxyl group-containing cellulose nanofibers. For example, a carboxyl group in the carboxyl group-containing cellulose nanofibers of the porous film may be covalently bound to a carbon of a pyranose ring. The carboxyl group may be represented by Formula 1 or Formula 2.

<Equation 1>

—R₁—O—R₂—COOM <Equation 1>

<Equation 2>

—O—R₂—COOM <Equation 2>

In Formulae 1 and 2, R₁ and R₂ may each independently be a substituted or unsubstituted C₁-C₁₀ alkylene group (i.e., divalent alkyl), and M may be hydrogen or an alkali metal. For example, the alkali metal may be lithium, sodium, or potassium. For example, R₁ and R₂ may each independently be a methylene group. For example, the carboxyl group in the carboxyl group-containing cellulose nanofibers, which is bound to a carbon that is part of a pyranose ring, may be —CH₂OCH₂COONa or —OCH₂COONa. The pyranose ring may be, for example, glucopyranose.

In this regard, the carboxyl group in the carboxyl group-containing cellulose nanofibers, which is represented by Formula 1 or Formula 2, wherein the carboxyl group having a —COOM structure is bound to a carbon that forms (is part of) a pyranose ring via —R₁—O—R₂— linking group or —O—R₂— linking group, is different from a carboxyl group having a —COOM structure that is directly bound to a carbon that forms (is part of) a pyranose ring without a linking group in oxidized cellulose nanofibers obtained by a conventional chemical oxidation reaction such as TEMPO-oxidized carboxyl group-containing cellulose nanofibers.

The content of the carboxyl group in the carboxyl group-containing cellulose nanofibers may be, for example, about 0.02 millimole per gram (mmol/g) or greater, about 0.06 mmol/g or greater, about 0.10 mmol/g or greater, about 0.15 mmol/g or greater, or about 0.20 mmol/g or greater. For example, the content of the carboxyl group in the carboxyl group-containing cellulose nanofibers of the porous film may be about 0.02 mmol/g to about 10 mmol/g, about 0.02 mmol/g to about 5 mmol/g, about 0.02 mmol/g to about 3 mmol/g, about 0.02 mmol/g to about 2 mmol/g, or about 0.02 mmol/g to about 1 mmol/g. When the cellulose nanofibers includes carboxyl group-containing cellulose nanofibers having a carboxyl group content within any of these ranges, a porous film including the cellulose nanofibers may have further improved tensile strength and tensile modulus. A method of measuring the carboxyl group content of the second cellulose nanofibers may be understood from the method detailed in Evaluation Example 5.

The small-diameter cellulose nanofibers (e.g., small-diameter carboxyl group-containing cellulose nanofibers) may have an average diameter of, for example, 50 nm or less, 45 nm or less, 40 nm or less, 35 nm or less, 30 nm or less, or 25 nm or less. The small diameter cellulose nanofibers of the porous film may have an average diameter of, for example, about 1nm to about 50nm, about 1nm to about 45nm, about 1 nm to about 40 nm, about 1 nm to about 35 nm, about 1 nm to about 30 nm, or about 1 nm to about 25 nm. When the porous film includes cellulose nanofibers, particularly carboxyl group-containing cellulose nanofibers, having an average diameter within any of these ranges, the porous film may have further improved tensile strength. A method of measuring the average diameter of carboxyl group-containing cellulose nanofibers may be understood from the method set out in Evaluation Example 6.

In a diameter distribution curve of the small diameter fibers (e.g., the carboxyl group-containing cellulose nanofibers) such as disclosed in FIG. 1B, a full width at half maximum (FWHM) of a diameter peak may be, for example, about 50 nm or less, about 45 nm or less, about 40 nm or less, about 35 nm or less, about 30 nm or less, about 25 nm or less, about 20 nm or less, about 15 nm or less, or about 10 nm or less. A FWHM of a diameter peak in a diameter distribution curve may be, for example, about 1 nm to about 45 nm, about 5 nm to about 45 nm, or about 10 nm to about 45 nm. When the porous film includes nanofibers having a narrow FWHM within any of these ranges, the porous film may have improved uniformity (i.e., a uniform Gurley value over the entire region of the porous film), and further improved tensile strength due to increased contact points between fibers.

The carboxyl group-containing cellulose nanofibers may be, for example, carboxyl group-containing microbial cellulose nanofibers (or bacterial cellulose nanofibers). For example, the carboxyl group-containing microbial cellulose nanofibers may be a fermentation product of a culture solution containing microorganisms, such that the nanofibers are directly obtained from the culture solution containing the microorganisms. Therefore, the carboxyl group-containing microbial cellulose nanofibers of the porous film of the present disclosure are distinct from a simple mixture of conventional microbial cellulose nanofibers and a carboxyl group-containing compound (e.g., it can be distinguished based on absorption spectra as discussed below). The carboxyl group-containing microbial cellulose nanofibers are also distinct from wood cellulose nanofibers obtained by decomposition of wood material.

For example, the carboxyl group-containing microbial cellulose nanofibers may be obtained by using a microorganism derived from the genus Enterobacter, Gluconacetobacter, Komagataeibacter, Acetobacter, Achromobacter, Agrobacterium, Alcaligenes, Azotobacter, Pseudomonas, Rhizobium, Sarcina, Klebsiella, or Escherichia. However, embodiments are not limited thereto. Any suitable microorganism available in the art capable of producing microbial celluloses may be used. For example, a microorganism of the genus Actetobacter may be Actetobacter pasteurianus. For example, a microorganism of the genus Agrobacterium may be Agrobacterium tumefaciens. For example, a microorganism of the genus Rhizobium may be Rhizobium leguminosarum. For example, a microorganism of the genus Sarcina may be Sarcina ventriculi. For example, a microorganism of the genus Gluconacetobacter may be Gluconacetobacter xylinum. For example, a microorganism of the genus Klebsiella may be Klebsiella pneumoniae. A microorganism of the genus Escherichia may be Escherichia coli.

The carboxyl group-containing microbial cellulose may have an absorption peak corresponding to a carboxyl group at about 1,572 cm⁻¹ in an infrared (IR) spectrum. Microbial celluloses not including a carboxyl group do not have the absorption peak.

In some embodiments, the porous film may further include common cellulose nanofibers, in addition to the microbial cellulose nanofibers. For example, the porous film may further include wood cellulose nanofibers. However, embodiments are not limited thereto. Any suitable cellulose nanofibers available in the art that are capable of improving tensile strength of a separator and have an average diameter of about 50 nm or less may be used.

In some embodiments, the porous film may further include at least one selected from a cross-linking agent, a binder, inorganic particles, and polyolefin. When the porous film further includes these components, it may be easy to control physical properties of the porous film. Due to the additional inclusion of a cross-linking agent and/or a binder, the porous film may have further improved tensile strength.

The cross-linking agent may facilitate binding of the cellulose nanofibers to one another. Any agent that can cross-link the cellulose nanofibers can be used. An amount of the cross-linking agent may be about 1 part to about 50 parts by weight with respect to 100 parts by weight of a total weight of the large-diameter fibers and the small-diameter fibers. However, embodiments are not limited thereto and any appropriate amount of the cross-linking agent that may improve physical properties of the porous film may be used. For example, the amount of the cross-linking agent may be about 1 to about 30 parts by weight, about 1 to about 20 parts by weight, or about 1 to about 15 parts by weight, each with respect to 100 parts by weight of a total weight of the large-diameter fibers and small-diameter fibers. For example, the cross-linking agent may be at least one selected from isocyanate, polyvinyl alcohol, and polyamide epichlorohydrin (PAE). However, embodiments are not limited thereto. Any suitable material available as a cross-linking agent in the art may be used.

The binder may facilitate binding of the cellulose nanofibers. An amount of the binder may be about 1 part to about 50 parts by weight with respect to 100 parts by weight of a total weight of the large-diameter fibers and small-diameter fibers. However, embodiments are not limited thereto. Any appropriate amount of the binder that may improve physical properties of the porous film may be used. The amount of the binder may be, for example, about 1 part to about 30 parts by weight, about 1 part to about 20 parts by weight, or about 1 part to about 15 parts by weight, each with respect to 100 parts by weight of a total weight of the large-diameter fibers and small-diameter fibers. For example, the binder may be at least one selected from cellulose single nanofiber, methyl cellulose, hydroxypropyl methylcellulose, hydroxyethyl methyl cellulose, carboxyl methyl cellulose, ethyl cellulose, polyvinylidene fluoride-co-hexafluoropropylene, polyvinylidene fluoride-co-trichloroethylene, polymethylmethacrylate, polyacrylonitrile, polyvinylpyrrolidone, polyvinylacetate, polyethylene-co-vinyl acetate, polyimide, polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, pullulan, and polyvinylalcohol. However, embodiments are not limited thereto. Any suitable material available as a binder in the art may be used.

The inorganic particles may improve mechanical properties of the porous film. An added amount of the inorganic particles may be about 0.01 parts to about 20 parts by weight with respect to 100 parts by weight of a total weight of the large-diameter fibers and the small-diameter fibers. However, embodiments are not limited to this range. The added amount of the inorganic particles may be within any range as long as the physical properties of the porous film may be improved. The amount of the inorganic particles may be, for example, about 0.01 parts to about 15 parts by weight, about 0.1 parts to about 10 parts by weight, or about 0.1 parts to about 5 parts by weight, each with respect to 100 parts by weight of a total weight of the large-diameter fibers and the small-diameter fibers. The inorganic particles may include, for example, a metal oxide selected from alumina (Al₂O₃), silica (SiO₂), titania (TiO₂), HfO_{2,} SrTiO_{3,} SnO_{2,} CeO_{2,} Na₂O, MgO, NiO, CaO, BaO, ZnO, ZrO_{2,} Y₂O_{3,} BaTiO_{3,} Li₂O, RaO, CaO, SrO, Sc₂O_{3,} Ce₂O_{3,} and a cage-structured silsesquioxane; a metal nitride selected from ZrN, TaN, HfN, VN, NbN, Cr₂N, TaN, CrN, GeN, TLi₃N, Mg₃N_{2,} Ca₃N_{2,} Sr₃N_{2,} Ba₃N_{2,} BN, AIN, and TiN; a metal oxynitride selected from a metal TaON (tantalum oxynitride), ZrOₓN_{y} (zirconium oxynitride, wherein 0<x<2 and 0<y<3), and LiPON (lithium phosphorus oxynitride); a metal carbide selected from TiC, ZrC, HfC, NbC, TaC, Cr₃C_{2,} Mo₂C, WC, and SiC; a metal-organic framework (MOF); a lithiated compound of the above-listed compounds; a ceramic conductor selected from Li_{1+x+y}AlₓTi₂₋ₓSi_{y}P_{3-y}O₁₂ (wherein 0<x<2 and 0≤y<3), BaTiO_{3,} Pb(Zr,Ti)O₃(PZT), Pb₁₋ₓLaₓZr_{1-y}Ti_{y}O₃(PLZT) (wherein 0≤x<1 and 0≤y<1), Pb(Mg₃Nb_{2/3})O₃-PbTiO₃(PMN-PT), lithium phosphate (Li₃PO₄), lithium titanium phosphate (LiₓTi_{y}(PO₄)_{3,} wherein 0<x<2 and 0<y<3), lithium aluminum titanium phosphate (LiₓAl_{y}Ti_{z}(PO₄)_{3,} wherein 0<x<2, 0<y<1, and 0<z<3), Li_{1+x+y}(Al, Ga)ₓ(Ti, Ge)₂₋ₓSi_{y}P_{3-y}O₁₂ (wherein 0≤x≤1and 0≤y≤1), lithium lanthanum titanate (LiₓLa_{y}TiO_{3,} wherein 0<x<2 and 0<y<3), lithium germanium thiophosphate (LiₓGe_{y}P_{z}S_{w}, wherein 0<x<4, 0<y<1, 0<z<1, and 0<w<5), lithium germanium thiophosphate (LiₓN_{y}, wherein 0<x<4 and 0<y<2), a SiS₂ (LiₓSi_{y}Sz, wherein 0<x<3, 0<y<2, and 0<z<4) glass, a P₂S₅ (LiₓP_{y}S_{z}, wherein 0<x<3, 0<y<3, and 0<z<7) glass, a Li₂O—Al₂O₃—SiO₂—P₂O₅—TiO₂—GeO₂ ceramic, and a garnet ceramic (Li₃₊ₓLa₃M₂O_{12,} wherein 0≤x≤5 M=Te, Nb, or Zr); a carbon nanostructure such as graphene, carbon nanotubes (CNTs), or carbon nanofibers (CNFs). However, embodiments are not limited thereto. Any material available in the art as inorganic particles for a separator may be used. The inorganic particles may have a size of, for example, about 1 nm to about 10 μm, about 10 nm to about 5 μm, or about 100 nm to about 1 μm. The inorganic particles may be located, for example, inside the porous film and/or on a surface of the porous film.

As used herein, the term “size” may refer to an average particle diameter when the particles are spherical. The size may also refer to the length of a major axis when the particles are of a rod-shape or an elliptical shape. As used herein, the terms “average particle size” or “average particle diameter” may refer to an average particle diameter (D50) corresponding to 50% in a cumulative distribution of total particles accumulated from smallest to largest in size, wherein the number of the total accumulated particles is assumed as 100%. The average particle size may be measured according to a method known to one of ordinary skill in the art, for example, using a particle size analyzer, transmission emission microscope (TEM) images, or scanning electron microscopy (SEM) images. Another method of measuring the average particle size may be using a measurement device based on dynamic light scattering, wherein an average particle diameter may be calculated from the number of particles within a certain size range counted using dynamic light scattering.

Polyolefin may be used as a material of a common porous film or the porous film according to one or more embodiments of the present disclosure. Such film may have improved flexibility. The polyolefin may be, for example, polyethylene or polypropylene. The polyolefin may include, for example, a single layer or a multilayer including at least two layers. The polyolefin may be, for example, a polyethylene/polypropylene double layer, a polyethylene/polypropylene/polyethylene triple layer, or a polypropylene/polyethylene/polypropylene triple layer. However, embodiments are not limited thereto. The polyolefin may have any layered structure including polyolefin used in the art.

In one or more embodiments, a contact angle of the porous film with water at 20° C. may be, for example, about 60° or less, about 50° or less, about 40° or less, about 30° or less, or about 20° or less. The porous film may have a small contact angle with a polar solvent such as water, and thus may provide improved wettability with respect to an electrolyte including the polar solvent. When a contact angle of the porous film with water at 20 ° C. is too high, it may be difficult to impregnate the porous film with the electrolyte. When the porous film according to one or more embodiments is used as a separator of a lithium battery, the porous film may provide improved wettability with respect to an electrolyte, and an interface between the separator and an electrode may be uniformly impregnated with the electrolyte. Accordingly, a reaction occurring at the interface between the separator and the electrode may be uniform, and this may prevent the formation of lithium dendrites caused by local overcurrent, and consequently, lifespan characteristics of an electrochemical device may improve. The contact angle is a static contact angle which is measured when a droplet is standing on a surface and the three phase boundary is not moving.

In one or more embodiments, a thermal shrinkage of the porous film after being left at 150° C. for 30 minutes may be about 5% or less, about 4.5% or less, about 4% or less, about 3.5% or less, about 3% or less, about 2.5% or less, about 2% or less, about 1.5% or less, or about 1% or less. Accordingly, the porous film may have high thermal stability at a high temperature of about 150 ° C. or greater, and an electrochemical device using the porous film as a separator may have improved thermal stability. A common olefin-based porous film rapidly shrinks at a high temperature of 150° C. to 200° C., thus interrupting operation of the battery. The thermal shrinkage is measured by a change of length of the porous film after placing the porous film in a vacuum drying oven at 90° C. for 60 min. Thermal shrinkage (%)=(Li−Lf)/Lf×100, wherein Li is an initial length of the porous film and Lf is a final length of the porous film in the machine direction (MD) after high temperature vacuum oven storage.

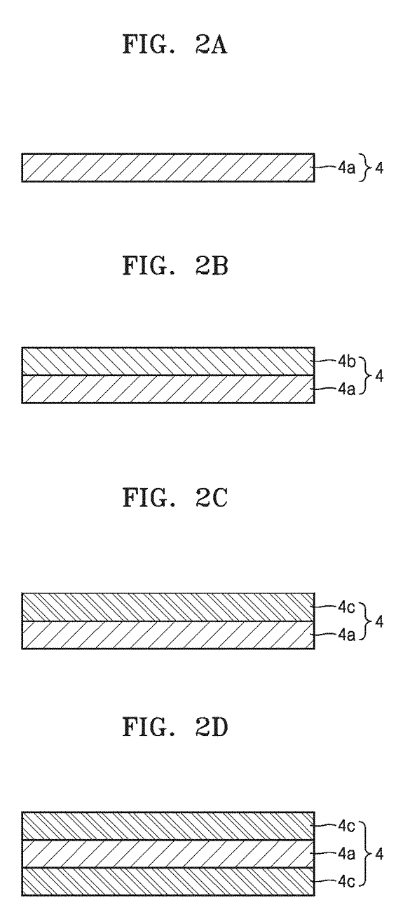

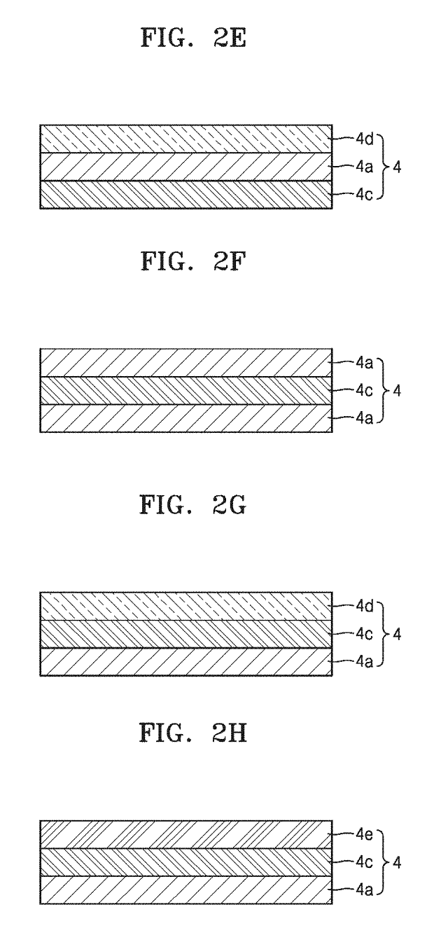

The porous film according to one or more embodiments may have various single-layer structures or multilayer structures according to performance requirements. Hereinafter, porous films according to embodiments having single-layer or multilayer structures will be described with reference to FIGS. 2A to 2H.

Referring to FIG. 2A, a porous film (4) according to an embodiment may have a single-layer structure including a first layer (4a) including small-diameter fibers and large-diameter fibers. For example, the first layer (4a) may include, as the large-diameter fibers, first cellulose nanofibers having an average diameter of about 100 nm or greater or polyethylene terephthalate (PET) fibers having an average diameter of about 2 μm or greater, and include, as the small-diameter fibers, second cellulose nanofibers having an average diameter of about 50 nm or less.

Referring to FIG. 2B, a porous film (4) according to an embodiment may have a multilayer structure including: a first layer (4a) including small-diameter fibers and large-diameter fibers; and a second layer (4b) on a surface of the first layer (4a), the second layer (4b) including polyolefin. For example, the first layer (4a) may include, as the large-diameter fibers, first cellulose nanofibers having an average diameter of about 100 nm or greater or polyethylene terephthalate (PET) fibers having an average diameter of about 2 μm or greater, and include, as the small-diameter fibers, second cellulose nanofibers having an average diameter of about 50 nm or less. For example, the second layer (4b) may include at least one polyolefin selected from polyethylene and polypropylene.

Referring to FIG. 2C, a porous film (4) according to an embodiment may have a multilayer structure including: a first layer (4a) including small-diameter fibers and large-diameter fibers; and a third layer (4c) on a surface of the first layer (4a), the third layer (4c) including small-diameter fibers or large-diameter fibers. For example, the first layer (4a) may include, as the large-diameter fibers, first cellulose nanofibers having an average diameter of about 100 nm or greater or polyethylene terephthalate (PET) fibers having an average diameter of about 2μm or greater, and include, as the small-diameter fibers, second cellulose nanofibers having an average diameter of about 50 nm or less. For example, the third layer (4c) may include first cellulose nanofibers or polyethylene terephthalate (PET) fibers alone as large-diameter fibers, or may include second cellulose nanofibers alone as small-diameter fibers.

Referring to FIG. 2D, a porous film (4) according to an embodiment may have a multilayer structure including: a first layer (4a) including small-diameter fibers and large-diameter fibers; and third layers (4c) on respective opposite surfaces of the first layer (4a), the third layers (4c) each including small-diameter fibers or large-diameter fibers. For example, the first layer (4a) may include, as the large-diameter fibers, first cellulose nanofibers having an average diameter of about 100 nm or greater or polyethylene terephthalate (PET) fibers having an average diameter of about 2 μm or greater, and include, as the small-diameter fibers, second cellulose nanofibers having an average diameter of about 50 nm or less. For example, the third layers (4c) may include first cellulose nanofibers or polyethylene terephthalate (PET) fibers alone as large-diameter fibers, or may include second cellulose nanofibers alone as small-diameter fibers.

Referring to FIG. 2E, a porous film (4) according to an embodiment may have a multilayer structure including: a first layer (4a) including small-diameter fibers and large-diameter fibers; a third layer (4c) on a surface of the first layer (4a), the third layer (4c) including small-diameter fibers or large-diameter fibers; and a fourth layer (4d) on a surface of the first layer (4a) opposite to the third layer (4c), the fourth layer (4d) including small-diameter fibers or large-diameter fibers and having a different composition from the composition of the third layer (4c). For example, the first layer (4a) may include, as the large-diameter fibers, first cellulose nanofibers having an average diameter of about 100 nm or greater or polyethylene terephthalate (PET) fibers having an average diameter of about 2um or greater, and include, as the small-diameter fibers, second cellulose nanofibers having an average diameter of about 50 nm or less. For example, the third layer (4c) and the fourth layer (4d) may each independently include first cellulose nanofibers or polyethylene terephthalate (PET) fibers alone as large-diameter fibers, or may include second cellulose nanofibers alone as small-diameter fibers.

Referring to FIG. 2F, a porous film (4) according to an embodiment may have a multilayer structure including: a third layer (4c) including small-diameter fibers or large-diameter fibers; and first layers (4a) on respective opposite surfaces of the third layer (4c), the first layers (4a) each including small-diameter fibers and large-diameter fibers. For example, the first layers (4a) may each include, as the large-diameter fibers, first cellulose nanofibers having an average diameter of about 100nm or greater or polyethylene terephthalate (PET) fibers having an average diameter of about 2 μm or greater, and include, as the small-diameter fibers, second cellulose nanofibers having an average diameter of about 50 nm or less. For example, the third layer (4c) may include first cellulose nanofibers or polyethylene terephthalate (PET) fibers alone as large-diameter fibers, or may include second cellulose nanofibers alone as small-diameter fibers.

Referring to FIG. 2G, a porous film (4) according to an embodiment may have a multilayer structure including: a third layer (4c) including small-diameter fibers or large-diameter fibers; a first layer (4a) on a surface of the third layer (4c), the first layer (4a) including small-diameter fibers and large-diameter fibers; and a fourth layer (4d) on a surface of the third layer (4c) opposite to the first layer (4a), the fourth layer (4d) including small-diameter fibers or large-diameter fibers and having a different composition from the composition of the third layer (4c). For example, the first layer (4a) may include, as the large-diameter fibers, first cellulose nanofibers having an average diameter of about 100 nm or greater or polyethylene terephthalate (PET) fibers having an average diameter of about 2 μm or greater, and include, as the small-diameter fibers, second cellulose nanofibers having an average diameter of about 50 nm or less. For example, the third layer (4c) and the fourth layer (4d) may each independently include first cellulose nanofibers or polyethylene terephthalate (PET) fibers alone as large-diameter fibers, or may include second cellulose nanofibers alone as small-diameter fibers, so long as the fourth layer (4d) has a different composition from the composition of the third layer (4c).

Referring to FIG. 2H, a porous film (4) according to an embodiment may have a multilayer structure including: a third layer (4c) including small-diameter fibers or large-diameter fibers; a first layer (4a) on a surface of the third layer (4c), the first layer (4a) including small-diameter fibers and large-diameter fibers; and a fifth layer (4e) on a surface of the third layer (4c) opposite to the first layer (4a), the fifth layer (4e) including small-diameter fibers and large-diameter fibers and having a different composition from the composition of the first layer (4a). For example, the first layer (4a) may include, as the large-diameter fibers, first cellulose nanofibers having an average diameter of about 100 nm or greater, and include, as the small-diameter fibers, second cellulose nanofibers having an average diameter of about 50 nm or less. For example, the fifth layer (4e) may include, as the large-diameter fibers, polyethylene terephthalate (PET) fibers having an average diameter of about 2 μm or greater, and include, as the small-diameter fibers, second cellulose nanofibers having an average diameter of about 50 nm or less. For example, the third layer (4c) may include first cellulose nanofibers alone as large-diameter fibers, or may include second cellulose nanofibers alone as small-diameter fibers.

In one of the embodiments of the porous film (4a) described above with reference to FIGS. 2A to 2H, at least one of the first layer (4a), the second layer (4b), the third layer (4c), the fourth layer (4d), and the fifth layer (4e) may further include at least one of a cross-linking agent, a binder, inorganic particles, and polyolefin.

In accordance with another aspect of the disclosure, a separator comprises the porous film according to the one or more embodiments detailed herein.

When the porous film of the present disclosure is used as a separator in an electrochemical device, the porous film may allow ion migration between the electrodes and block electrical contact between the electrodes, thereby improving performance of the electrochemical device. In addition, due to the suppressed side reaction between the porous film and the liquid electrolyte, deterioration of the electrochemical device may be suppressed. In other words, the electrochemical device may have improved cycle characteristics.

In accordance with another aspect of the disclosure, an electrochemical device includes a positive electrode, a negative electrode, and the separator according to any of the above-described embodiments located between the positive electrode and the negative electrode. Due to the inclusion of the separator according to any of the above-described embodiments, deterioration of the electrochemical device may be inhibited, and consequently, the electrochemical device may have improved lifespan characteristics.

The electrochemical device is not particularly limited, and may be any device known in the art to store and/or emit electricity by an electrochemical reaction. The electrochemical device may be, for example, an electrochemical cell or an electric double-layer capacitor. The electrochemical device may be an alkali metal battery, for example, a lithium battery or a sodium battery, or a fuel battery. The electrochemical cell may be a primary battery or a rechargeable secondary battery. The lithium battery may be a lithium ion battery, a lithium polymer battery, a lithium sulfur battery, or a lithium air battery.

For example, a lithium battery may be manufactured according to the following method. However, embodiments are not limited thereto, and any manufacturing method that enables operation of a lithium battery may be used.

First, a negative electrode may be manufactured according to the following method.

A negative active material, a conducting agent, a binder, and a solvent may be mixed to prepare a negative active material composition. This negative active material composition may be directly coated on a current collector, for example, a copper foil, to manufacture a negative electrode. In some embodiments, the negative active material composition may be cast on a separate support to form a negative active material film. This negative active material film may then be separated from the support and laminated on a copper current collector, to thereby manufacture a negative electrode. The negative electrode is not limited to these examples, and may have any shape.

The negative active material may be any suitable negative active material for a lithium battery available in the art. For example, the negative active material may be at least one selected from lithium metal, a metal alloyable with lithium, a transition metal oxide, a non-transition metal oxide, and a carbonaceous material.

The metal alloyable with lithium may be, for example, silicon (Si), tin (Sn), aluminum (Al), germanium (Ge), lead (Pb), bismuth (Bi), antimony (Sb), a Si—Y alloy (wherein Y may be an alkali metal, an alkaline earth metal, a Group 13 element, a Group 14 element, a transition metal, a rare earth element, or a combination thereof, and Y is not Si), or a Sn—Y alloy (wherein Y may be an alkali metal, an alkaline earth metal, a Group 13 element, a Group 14 element, a transition metal, a rare earth element, or a combination thereof, and Y is not Sn). For example, Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), polonium (Po), or a combination thereof.

The transition metal oxide may be, for example, a lithium titanium oxide, a vanadium oxide, or a lithium vanadium oxide.

The non-transition metal oxide may be, for example, SnO₂ or SiOₓ (wherein 0<x<2).

The carbonaceous material may be, for example, crystalline carbon, amorphous carbon, or a mixture thereof. Examples of the crystalline carbon may include graphite, such as natural graphite or artificial graphite that are in amorphous, plate, flake, spherical, or fibrous form. Examples of the amorphous carbon may include soft carbon (carbon sintered at low temperatures), hard carbon, meso-phase pitch carbides, and sintered cokes.

The conducting agent may be acetylene black, natural graphite, artificial graphite, carbon black, Ketjen black, carbon fiber, metal powder, or metal fiber of, for example, copper, nickel, aluminum, or silver. In some embodiments, the conducting agent may include at least one conductive material such as a polyphenylene derivative, which may be used alone or in a combination. However, embodiments are not limited thereto. Any suitable conducting agent available in the art may be used. Any of the above-described carbonaceous materials may be added as the conducting agent.

Examples of the binder may include a vinylidene fluoride/hexafluoropropylene copolymer, polyvinylidene fluoride (PVDF), polyacrylonitrile, polymethylmethacrylate, polytetrafluoroethylene, and mixtures thereof. The binder may be, for example, a styrene-butadiene rubber polymer. However, embodiments are not limited thereto. Any suitable material available as a binder in the art may be used.

The solvent may be, for example, N-methyl-pyrrolidone, acetone, or water. However, embodiments are not limited thereto. Any suitable material available as a solvent in the art may be used.

The amounts of the negative active material, the conducting agent, the binder, and the solvent may substantially be the same as those generally used in lithium batteries. At least one of the conducting agent and the solvent may be omitted according to the use and the structure of a lithium battery.

Next, a positive electrode may be manufactured according to the following method.

A positive electrode may be manufactured in the same manner as the negative electrode, except that a positive active material is used in place of the negative active material. The same conducting agent, binder, and solvent used to manufacture the negative electrode may also be used to prepare a positive active material composition.

For example, a positive active material, a conducting agent, a binder, and a solvent may be mixed to prepare a positive active material composition. This positive active material composition may be directly coated on an aluminum current collector to manufacture a positive electrode plate. In some embodiments, the positive active material composition may be cast on a separate support to form a positive active material film. This positive active material film may then be separated from the support and laminated on an aluminum current collector to manufacture a positive electrode plate. The positive electrode is not limited to these examples, and may have any form.

The positive active material may include at least one selected from the group consisting of lithium cobalt oxide, lithium nickel cobalt manganese oxide, lithium nickel cobalt aluminum oxide, lithium iron phosphorous oxide, and lithium manganese oxide. However, embodiments are not limited thereto. Any suitable positive active material available in the art may be used.

In some embodiments, the positive active material may be a compound represented by one of the following formulae: LiₐA_{1-b}B_{b}D₂ (wherein 0.90≤a≤1.8 and 0 ≤b≤0.5); LiₐE_{1-b}B_{b}O_{2-c}D_{c} (wherein 0.90≤a≤1.8, 0 ≤b 0.5, 0 ≤c≤0.05); LiE_{2-b}B_{b}O_{4-c} D_{c} (wherein 0≤b≤0.5 and 0≤c≤0.05); LiₐNi_{i-b-c}Co_{b}B_{c}D_{α}(wherein 0.90≤a≤1.8, 0 ≤b≤0.5, 0 c≤0.05, and 0 <α≤2); LiₐNi_{1-b-c}Co_{b}B_{c}O_{2-α}F_{α}(wherein 0.90 ≤a ≤1.8, 0≤b ≤0.5, 0 ≤c≤0.05, and 0<α<2); LiₐNi_{1-b-c}Co_{b}B_{c}O_{2-α}F₂ (wherein 0.90 ≤a ≤1.8, 0 ≤b ≤0.5, 0 ≤c≤0.05, and 0<α<2); LiₐNi_{1-b-c}Mn_{b}B_{c}D₆₀ (wherein 0.90≤a≤1.8, 0≤b≤0.5, 0 ≤c≤0.05, and 0<α<2); LiₐNi_{1-b-c}Mn_{b}B_{c}O_{2-α}F_{α} (wherein 0.90≤a≤1.8, 0 ≤b≤0.5, 0 ≤c≤0.05, and 0 <α<2); LiₐNi_{1-b-c}Mn_{b}B_{c}O_{2-α}F₂ (wherein 0.90≤a≤1.8, 0≤b≤0.5, 0 ≤c ≤0.05, and 0 <α<2); LiₐNi_{b}E_{c}G_{d}O₂ (wherein 0.90 ≤a≤1.8, 0 b≤0.9, 0≤c≤0.5, and 0.001≤d≤0.1); LiₐNi_{b}Co_{c}Mn_{d}GeO₂) (wherein 0.90≤a≤1.8, 0≤b≤0.9, 0≤c≤0.5, 0≤d≤0.5, and 0.001 ≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂G_{b}O₄ (wherein 0.90≤a≤1.8 and 0.001≤b≤0.1); QO₂; QS_{2;} LiQS_{2;} V₂O_{5;} LiV₂O_{5;} LiIO_{2;} LiNiVO_{4;} Li_{(3-f)}J₂(PO₄)₃ (wherein 0≤f≤2); Li_{(3-f)}Fe₂(PO₄)₃ (wherein0≤f≤2); and LiFePO₄.

In the foregoing formulae, A may be nickel (Ni), cobalt (Co), manganese (Mn), or a combination thereof; B may be aluminum (Al), Ni, Co, Mn, chromium (Cr), iron (Fe), magnesium (Mg), strontium (Sr), vanadium (V), a rare earth element, or a combination thereof; D may be oxygen (O), fluorine (F), sulfur (S), phosphorus (P), or a combination thereof; E may be Co, Mn, or a combination thereof; F may be F, S, P, or a combination thereof; G may be Al, Cr, Mn, Fe, Mg, lanthanum (La), cerium (Ce), Sr, V, or a combination thereof; Q may be titanium (Ti), molybdenum (Mo), Mn, or a combination thereof; I may be Cr, V, Fe, scandium (Sc), yttrium (Y), and a combination thereof; and J may be selected from V, Cr, Mn, Co, Ni, copper (Cu), or a combination thereof.

The compounds listed above as positive active materials may have a surface coating layer (hereinafter, also referred to as “coating layer”). Alternatively, a mixture of a compound without a coating layer and a compound having a coating layer, the compounds being selected from the above-listed compounds, may be used. In one or more embodiments, the coating layer may include at least one compound of a coating element selected from oxide, hydroxide, oxyhydroxide, oxycarbonate, and hydroxycarbonate of the coating element. In one or more embodiments, the compounds for the coating layer may be amorphous or crystalline. In one or more embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In one or more embodiments, the coating layer may be formed using any of the above-listed compounds and the coating elements for the coating layer by using any suitable method that does not adversely affect the physical properties of the positive active material. For example, the coating layer may be formed using a spray coating method or a dipping method. The coating method may be easily understood by those of ordinary skill in the art, and thus a detailed description thereof is herein omitted.

Examples of the positive active material may include LiCoO_{2,} LiCoO_{2,} LiMnₓO₂ₓ (wherein x=1 or 2), LiNi₁₋ₓMnₓO₂ (wherein 0<x<1), LiNi_{1-x-y}CoₓMn_{y}O₂ (wherein 0≤x≤0.5 and O≤y≤0.5), and LiFePO₄.

Next, the separator according to any of the above-described embodiments may be disposed between the positive electrode and the negative electrode.

Next, an electrolyte may be prepared.

The electrolyte may be, for example, an organic liquid electrolyte. In some embodiments, the electrolyte may be a solid electrolyte. For example, the solid electrolyte may be boron oxide or lithium oxynitride. However, embodiments are not limited thereto. Any suitable material available as a solid electrolyte in the art may be used. The solid electrolyte may be formed on the negative electrode by, for example, sputtering, atomic layer deposition (ALD), chemical vapor deposition (CVD), or physical vapor deposition (PVD).

The organic liquid electrolyte may be prepared as follows. For example, the organic liquid solution may be prepared by dissolving a lithium salt in an organic solvent.

The organic solvent may be any suitable solvent available in the art. For example, the organic solvent may be propylene carbonate, ethylene carbonate, fluoroethylene carbonate, butylene carbonate, dimethylcarbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyl tetrahydrofuran, y-butyrolactone, dioxolan, 4-methyl dioxolan, N, N-dimethylformamide, dimethylacetamide, dimethylsulfoxide, dioxane, 1,2-dimethoxyethane, sulfolane, dichloroethane, chlorobenzene, nitrobenzene, diethylene glycol, dimethyl ether, or a combination thereof.

The lithium salt may be any suitable material available as a lithium salt in the art. For example, the lithium salt may be LiPF_{6,} LiBF_{4,} LiSbF_{6,} LiAsF_{6,} LiCIO₄, LiCF₃SO_{3,} Li(CF₃SO₂)₂N, LiC₄F₉SO_{3,} LiAlO_{2,} LiAIC_{4,} LiN(CₓF₂ₓ₊₁SO₂)(C_{y}F_{2y+1}SO₂) (wherein x and y are each independently a natural number), LiCI, Lil, or a mixture thereof.

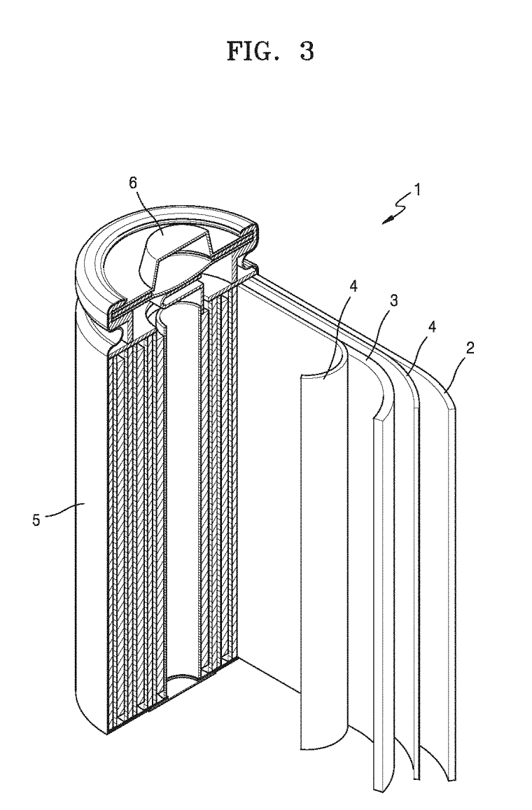

Referring to FIG. 3, a lithium battery (1) according to an embodiment may include a positive electrode (3), a negative electrode (2), and a separator (4). The positive electrode (3), the negative electrode (2), and the separator (4) may be wound or folded, and then sealed in a battery case (5). The battery case (5) may be filled with an organic liquid electrolyte and sealed with a cap assembly (6), thereby completing the manufacture of the lithium battery (1). The battery case (5) may be a cylindrical type, a rectangular type, or a thin-film type. The lithium battery (1) may be, for example, a thin-film type battery. The lithium battery (1) may be, for example, a lithium ion battery.

In some embodiments, the separator according to any of the embodiments of the present disclosure may be disposed between a positive electrode and a negative electrode to provide a battery assembly. The battery assembly may be stacked in a bi-cell structure and impregnated with the organic liquid electrolyte. The resultant assembly may be put into a pouch and hermetically sealed, thereby completing the manufacture of a lithium ion polymer battery.

In one or more embodiments of the present disclosure, one or more battery assemblies may form a battery module. A plurality of battery modules may be stacked to form a battery pack, which may then be used in a device that requires large capacity and high power, for example, in a laptop computer, a smartphone, or an electric vehicle.

The lithium battery may have improved lifespan characteristics and high-rate characteristics, and thus may be suitable for use in an electric vehicle (EV), for example, in a hybrid vehicle such as a plug-in hybrid electric vehicle (PHEV).

In accordance with another aspect of the disclosure, a method of preparing a porous film includes: preparing a composition including large-diameter fibers, small-diameter fibers, a hydrophilic pore-forming agent, and a solvent, and coating the composition on a substrate; drying the composition to form a sheet on the substrate; and separating the sheet from the substrate, thereby obtaining the sheet as the porous film. Due to the inclusion of the large-diameter fibers and the small-diameter fibers, the porous film may be improved in both mechanical properties and air permeability. Accordingly, a lithium battery including the porous film may be improved in both energy density and power output.

In the porous film preparation method according to one or more embodiments, the composition may include large-diameter fibers having an average particle diameter of about 100 nm or greater and small-diameter fibers having an average diameter of about 50 nm or less. The large-diameter fibers may include, for example, first cellulose fibers, and/or heat-resistant polymer fibers, or the like. The small-diameter fibers may include, for example, second cellulose fibers.

In the porous film preparation method according to one or more embodiments, the solvent may be, for example, water. However, embodiments are not limited thereto. For example, the solvent may be an organic solvent, for example, an alcohol, such as methanol, ethanol, propanol, or isopropyl alcohol; or acetone. Any suitable solvent available in the art may be used.

In the porous film preparation method according to one or more embodiments, the composition may further include at least one selected from a cross-linking agent and a binder. When the composition further includes a cross-linking agent and/or a binder, the resulting porous film may have further improved tensile strength. Examples of the cross-linking agent and the binder may be the same as the above-described examples of the cross-linking agent and the binder included in the porous film.

The hydrophilic pore-forming agent may be at least one selected from pore-forming agents that are in a solid at room temperature, such as polyethylene glycol, ethylene carbonate, vinylene carbonate, propane sulfone, ethylene sulfate, dimethyl sulfone, ethyl methyl sulfone, dipropyl sulfone, dibutyl sulfone, trimethylene sulfone, tetramethylene sulfone, di(methoxyethyl) sulfone (CH₃OCH₂CH₂)₂SO₂), and ethylcyclopentylsulfone (C₂H₅SO₂C₅H₉); and pore-forming agents that are in a liquid at room temperature, such as 1,5-pentanediol, 1-methylamino-2,3-propanediol, ϵ-caprolactone, γ-butyrolactone, α-acetyl-y-butyrolactone, diethylene glycol, 1,3-butylene glycol, propylene glycol, triethylene glycol dimethyl ether, tripropylene glycol dimethyl ether, diethylene glycol monobutyl ether, triethylene glycol monomethyl ether, triethylene glycol butyl methyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, diethylene glycol monoisopropyl ether, ethylene glycol monoisobutyl ether, tripropylene glycol monomethyl ether, diethylene glycol methyl ethyl ether, diethylene glycol diethyl ether, glycerin, propylene carbonate, and N-methylpyrrolidone. However, embodiments are not limited thereto. Any pore-forming agent available in the art may be used.

When a hydrophilic pore-forming agent that is solid at room temperature is used, the water content of the composition may decrease as water evaporates from the composition, such that the pore-forming agent may be precipitated exceeding a solubility limit thereof. Accordingly, the pore-forming agent may be dispersed in a solid state in the sheet, which may inhibit further change of its agglomeration or arrangement state caused by further water evaporation. Accordingly, the porous film may have improved uniformity of pore size and pore distribution.

In one or more embodiments, the porous film preparation method may further include washing the porous film or the sheet with an organic solvent. By washing the porous film or the sheet with an organic solvent, the remaining pore-forming agent may be effectively removed from the porous film or the sheet. The washing method and the number of washings are not particularly limited, and may be performed one or more times to control required physical properties of the porous film. The organic solvent used for washing the porous film or the sheet may be any suitable solvent available in the art that may dissolve the hydrophilic pore-forming agent. For example, the organic solvent may be toluene. In the porous film preparation method according to one or more embodiments, after removing the hydrophilic pore-forming agent that is solid at room temperature by using an organic solvent, the drying of the washed porous film may be performed, wherein the temperature and the duration of the drying are not particularly limited. For example, the washed porous film may be dried at a temperature ranging from about 20° C. to about 120° C. for 1 minute to about 10 hours. For example, the drying may be performed under atmospheric pressure or in a vacuum oven.

In the porous film preparation method according to one or more embodiments, the composition may include water as the solvent. However, embodiments are not limited thereto. The composition may further include, in addition to water, an additional solvent capable of dissolving the large-diameter fibers and the smaller-diameter fibers and the hydrophilic pore-forming agent that is solid at room temperature.

In the porous film preparation method according to one or more embodiments, a total amount of the large-diameter fibers and the small-diameter fibers in the composition may be, for example, about 0.01 wt % to about 50 wt %, about 0.05 wt % to about 40 wt %, about 0.1 wt % to about 30 wt %, about 0.2 wt % to about 20 wt %, about 0.3 wt % to about 15 wt %, about 0.3 wt % to about 10 wt %, about 0.35 wt % to about 8 wt %, about 0.4 wt % to about 6 wt %, or about 0.4 wt % to about 5 wt %, each based on a total weight of the composition. When the amount of the large-diameter fibers and the small-diameter fibers is too small, drying may take too much time, leading to reduced productivity, and the porous film may have reduced tensile strength. When the amount of the large-diameter fibers and the small-diameter fibers is too large, the composition may have an excessively increased viscosity, so that a uniform sheet may not be obtained.

In the porous film preparation method according to one or more embodiments, the amount of the hydrophilic pore-forming agent in the composition may be, for example, about 0.1 wt % to about 50 wt %, about 0.5 wt % to about 50 wt %, about 1 wt % to about 50 wt %, about 2 wt % to about 40 wt %, about 3 wt % to about 30 wt %, about 4 wt % to about 20 wt %, about 5 wt % to about 15 wt %, about 6 wt % to about 14 wt %, about 7 wt % to about 13 wt %, about 8 wt % to about 12 wt %, or about 9 wt % to about 11 wt %, each based on a total weight of the composition. In some other embodiments, the amount of the hydrophilic pore-forming agent in the composition may be, for example, about 1 vol % to about 99 vol %, about 5 vol % to about 95 vol %, or about 10 vol % to about 90 vol %, each based on a total volume of the large-diameter fibers, the small-diameter fibers, and the hydrophilic pore-forming agent. When the amount of the hydrophilic pore-forming agent is too small, the obtained porous film may have too small porosity, which may increase internal resistance of a lithium battery when used as a separator of the lithium battery, thereby deteriorating cycle characteristics of the lithium battery. When the amount of the hydrophilic pore-forming agent is too high, the porosity of the obtained porous film may be too large, which may cause a short circuit when used as a separator of a lithium battery, thereby lowering stability of the lithium battery.

In the porous film preparation method according to one or more embodiments, the drying of water of the composition may be performed at any temperature, for example, about 50° C. to about 120° C. for about 1 min to about 10 hours. The drying may be performed under atmospheric pressure or in a vacuum oven.

One or more embodiments of the present disclosure will now be described in detail with reference to the following examples. However, these examples are only for illustrative purposes and are not intended to limit the scope of the one or more embodiments of the present disclosure.

(Preparation of Cellulose Nanofibers)

### PREPARATION EXAMPLE 1

### Preparation of Carboxyl Group-Containing Microbial Cellulose Nanofibers

A wild-type Gluconacetobacter xylinum strain (KCCM 41431) was added to 700 milliliters (mL) of Hestrin-Schramm (HS) medium in a 1-liter (L) fermentor (GX LiFlus Series Jar-type open system, available from Hanil Science Industrial, a positive pressure was maintained to prevent contamination), the HS medium including 1.0 weight/volume percent (w/v %) of carboxymethyl cellulose (Na-CMC, available from Sigma Aldrich) having a molecular weight of 250,000 Daltons added thereto, and then incubated at a temperature of about 30° C. for about 48 hours while stirring with an impeller at about 250 rμm. The HS medium included 20 grams per liter (g/L) of glucose, 5 g/L of bacto-peptone, 5 g/L of yeast extract, 2.7 g/L of Na₂HPO_{4,} and 1.15 g/L of citric acid in water.

A fermented broth, including the resulting, uniformly distributed carboxyl-group-containing cellulose nanofibers, e.g., in a paste form, was collected. The fermented broth was washed with distilled water three times, and heated in a 2% NaOH aqueous solution for 15 minutes at a temperature of 121° C. to thereby hydrolyze the cells and impurities present among the carboxyl group-containing cellulose nanofibers. Subsequently, the resultant was washed with distilled water to obtain purified carboxyl group-containing cellulose nanofibers. The purified carboxyl group-containing cellulose nanofibers were mixed with water to prepare a 0.5 wt % carboxyl group-containing cellulose nanofiber suspension. The prepared suspension was homogenized by using a homogenizer (HG-15A, available from Daehan Science, Korea) to prepare 500 mL of a 0.5 wt % (w/w) homogenized carboxyl group-containing cellulose nanofiber suspension.

Subsequently, the homogenized fermented broth was passed twice through a microchannel (Interaction chamber, size: 200 μm) of a nano disperser (ISA-NH500, available from Ilshin Autoclave Co. Ltd, Korea), i.e., a high-pressure homogenizer, under a pressure of 300 bar, to thereby obtain a high-pressure homogenized fermented broth containing carboxyl group-containing cellulose nanofibers. The high-pressure homogenized fermented broth containing carboxyl-group-containing cellulose nanofibers was centrifuged to obtain a cellulose precipitate. The precipitate was heated in a 0.1N NaOH aqueous solution at a temperature of 121° C. for about 15 minutes to thereby hydrolyze the cells and impurities present among the carboxyl-group-containing cellulose nanofibers. Subsequently, the resultant was washed with distilled water to obtain purified carboxyl group-containing cellulose nanofibers.

The prepared carboxyl group-containing cellulose nanofibers had an average diameter of 18 nm, an amount of 0.11 millimoles per gram (mmol/g), and a weight-average degree of polymerization of about 5,531 DPw.

### PREPARATION EXAMPLE 2

### Preparation of Wood Cellulose Nanofibers of 100 nm or Greater

Commercially available wood cellulose nanofibers having an average diameter of 119.7 nm (BiNFi-s Wma-10002, Sugino Machine Ltd.) were purchased and used as is.

### PREPARATION EXAMPLE 3: Preparation of Wood Cellulose Nanofibers of 50 nm or Less

Wood cellulose nanofibers having an average diameter of 41.4 nm (prepared using aqueous counter collision (ACC), available from CNNT, South Korea) were purchased and used as is.

### PREPARATION EXAMPLE 4

### Preparation of PET Fibers

Polyethylene terephthalate (PET) fibers having an average diameter of 2 μm (TAO4PN, Teijin Ltd.) were purchased and used as is.

(Preparation of Porous Films)

### EXAMPLE 1

### Use of Small-Diameter Fibers and Large-Diameter Fibers (Wood Cellulose Fibers of 100 nm or Greater) in 80:20

A mixture of the small-diameter microbial cellulose nanofibers prepared in Preparation Example 1 and the large-diameter wood cellulose nanofibers prepared in Preparation Example 2 in a weight ratio of about 80:20 was diluted with water to obtain a 0.5 wt % aqueous dispersion. 90 parts by volume (90%(v/v) of polyethylene glycol (PEG, Mn=1,000) as a pore-forming agent, with respect to 100 parts by volume of a total solid volume (total volume of the nanofibers and the pore-forming agent), were added to 30 mL of the dispersion and stirred at room temperature at about 1000 rpm for about 1 hour. The obtained composition was coated on a polyester film substrate to a thickness of about 1.5 mm by using a micrometer adjustable applicator and then dried in an 85° C.-oven for about 3 hours to remove water, thereby obtaining a film. This film was then immersed in toluene and washed 4 to 5 times with toluene to remove the polyethylene glycol, and then dried at room temperature for about 4 hours, thereby obtaining a porous film. The obtained porous film (i.e., sheet as a porous film) was a non-woven fabric.

The obtained porous film was used as it was as a separator.

The 0.5 wt % aqueous dispersion of the mixture of the small-diameter microbial cellulose nanofibers prepared in Preparation Example 1 and the large-diameter wood cellulose nanofibers prepared in Comparative Preparation Example 1 in a weight ratio of about 80:20 was observed using a transmission electron microscope (TEM, Super TEM, available from Titan Cubed). Several TEM images of the aqueous dispersion were obtained and analyzed using an image analyzer. Diameters and lengths of 100 fibers were measured to calculate an average diameter and an average length.

FIG. 1A is a TEM image of the dispersion. In FIG. 1A, relatively thick fibers are wood cellulose nanofibers, and relatively thin fibers are microbial cellulose nanofibers.

FIG. 1B is a graph of diameter distribution of the nanofibers analyzed using the image analyzer. Referring to FIG. 1B, one peak appeared at diameters of 50 nm or less, and one peak appeared at diameters of 100 nm or greater.

Accordingly, the dispersion was found to include both the large-diameter wood cellulose nanofibers having an average diameter of about 100 nm or greater and the small-diameter microbial cellulose nanofibers having an average diameter of about 50 nm or less.

### EXAMPLE 2

### Use of Small-Diameter Fibers and Large-Diameter Fibers (Wood Cellulose Fibers of 100 nm or Greater) in a Ratio of 70:30

A porous film was prepared in the same manner as in Example 1, except that the mixing ratio of the small-diameter microbial cellulose nanofibers prepared in Preparation Example 1 and the large-diameter wood cellulose nanofibers prepared in Preparation Example 2 was changed to about 70:30 by weight.

### EXAMPLE 3:

### Use of Small-Diameter Fibers and Large-Diameter Fibers (Wood Cellulose Fibers of 100 nm or Greater) in a Ratio of 50:50

A porous film was prepared in the same manner as in Example 1, except that the mixing ratio of the small-diameter microbial cellulose nanofibers prepared in Preparation Example 1 and the large-diameter wood cellulose nanofibers prepared in Preparation Example 2 was changed to about 50:50 by weight.

### EXAMPLE 4

### Use of Small-Diameter Fibers and Large-Diameter Fibers (Wood Cellulose Fibers of 100 nm or Greater) in a Ratio of 40:60

A porous film was prepared in the same manner as in Example 1, except that the mixing ratio of the small-diameter microbial cellulose nanofibers prepared in Preparation Example 1 and the large-diameter wood cellulose nanofibers prepared in Preparation Example 2 was changed to about 40:60 by weight.

### COMPARATIVE EXAMPLE 1

### Use of Small-Diameter Fibers and Large-Diameter Fibers (Wood Cellulose Fibers of 100 nm or Greater) in a Ratio of 100:0

A porous film was prepared in the same manner as in Example 1, except that the mixing ratio of the small-diameter microbial cellulose nanofibers prepared in Preparation Example 1 and the large-diameter wood cellulose nanofibers prepared in

Preparation Example 2 was changed to about 100:0 by weight (no large-diameter fibers were used).

### COMPARATIVE EXAMPLE 2

### Use of Small-Diameter Fibers and Large-Diameter Fibers (Wood Cellulose Fibers of 100 nm or Greater) in a Ratio of 30:70

A porous film was prepared in the same manner as in Example 1, except that the mixing ratio of the small-diameter microbial cellulose nanofibers prepared in Preparation Example 1 and the large-diameter wood cellulose nanofibers prepared in Preparation Example 2 was changed to about 30:70 by weight.

### COMPARATIVE EXAMPLE 3

### Use Of Small-diameter Fibers And Large-diameter Fibers (Wood Cellulose Fibers of 100 nm or Greater) in a Ratio of 0:100

A porous film was prepared in the same manner as in Example 1, except that the mixing ratio of the small-diameter microbial cellulose nanofibers prepared in Preparation Example 1 and the large-diameter wood cellulose nanofibers prepared in Preparation Example 2 was changed to a about 0:100 by weight (no small-diameter fibers were used).

### COMPARATIVE EXAMPLE 4

### Use of Small-Diameter Fibers (Microbial Cellulose Nanofibers of 50 nm or Less) and Small-Diameter Fibers (Wood Cellulose Fibers of 50 nm or Less) in a Ratio of about 80:20

A mixture of the small-diameter microbial cellulose nanofibers prepared in Preparation Example 1 and the small-diameter wood cellulose nanofibers prepared in Preparation Example 3 in a weight ratio of about 80:20 was diluted with water to obtain a 0.5 wt % aqueous dispersion. 90 parts by volume (90% (v/v) of polyethylene glycol (PEG, Mn=1,000) as a pore-forming agent, with respect to 100 parts by volume of a total solid volume (total volume of the nanofibers and the pore-forming agent), were added to 30 mL of the dispersion and stirred at room temperature at about 1000 rpm for about 1 hour. The obtained composition was coated on a polyester film substrate to a thickness of about 1.5 mm by using a micrometer adjustable applicator and then dried in an 85° C.-oven for about 3 hours to remove water, thereby obtaining a film. This film was then immersed in toluene and washed 4 to 5 times with toluene to remove the polyethylene glycol, and then dried at room temperature for about 4 hours, thereby obtaining a porous film. The obtained porous film was a non-woven fabric.

The obtained porous film was used as a separator.

### COMPARATIVE EXAMPLE 5

### Use of Small-Diameter Fibers and Small-Diameter Fibers (Wood Cellulose Fibers of 50 nm or Less) in a Ratio of 75:25

A porous film was prepared in the same manner as in Comparative Example 4, except that the mixing ratio of the small-diameter microbial cellulose nanofibers prepared in Preparation Example 1 and the small-diameter wood cellulose nanofibers prepared in Preparation Example 3 was changed to about 75:25 by weight.

### COMPARATIVE EXAMPLE 6

### Use of Small-Diameter Fibers and Small-Diameter Fibers (Wood Cellulose Fibers of 50 nm or Less) in a Ratio of 50:50

A porous film was prepared in the same manner as in Comparative Example 4, except that the mixing ratio of the small-diameter microbial cellulose nanofibers prepared in Preparation Example 1 and the small-diameter wood cellulose nanofibers prepared in Preparation Example 3 was changed to about 50:55 by weight.

### EXAMPLE 5

### Use of Small-Diameter Fibers and Large-Diameter Fibers (PET) in a Ratio of 80:20

A mixture of the small-diameter microbial cellulose nanofibers prepared in Preparation Example 1 and the large-diameter polyethylene terephthalate (PET) fibers prepared in Preparation Example 4 in a weight ratio of about 80:20 was diluted with water to obtain a 0.5wt % aqueous dispersion. 90 parts by volume (90%(v/v) of polyethylene glycol (PEG, Mn=1,000) as a pore-forming agent, with respect to 100 parts by volume of a total solid volume (total volume of the nanofibers and the pore-forming agent), were added to 30 mL of the dispersion and stirred at room temperature at about 1000 rpm for about 1 hour. The obtained composition was coated on a polyester film substrate to a thickness of about 1.5 mm by using a micrometer adjustable applicator and then dried in an 85° C.-oven for about 3 hours to remove water, thereby obtaining a film. This film was then immersed in toluene and washed 4 to 5 times with toluene to remove the polyethylene glycol, and then dried at room temperature for about 4 hours, thereby obtaining a porous film. The obtained porous film was a non-woven fabric.

The obtained porous film was used as it was as a separator.

### EXAMPLE 6

### Use of Small-Diameter Fibers and Large-Diameter Fibers (PET) in a Ratio of 60:40

A porous film was prepared in the same manner as in Example 5, except that the mixing ratio of the small-diameter microbial cellulose nanofibers prepared in Preparation Example 1 and the large-diameter PET fibers prepared in Preparation Example 4 was changed to about 60:40 by weight.

### EXAMPLE 7

### Use of Small-Diameter Fibers and Large-Diameter Fibers (PET) in a Ratio of 50:50

A porous film was prepared in the same manner as in Example 5, except that the mixing ratio of the small-diameter microbial cellulose nanofibers prepared in Preparation Example 1 and the large-diameter PET fibers prepared in Preparation Example 4 was changed to about 50:50 by weight.

### COMPARATIVE EXAMPLE 7

### Use of Small-Diameter Fibers and Large-Diameter Fibers (PET) in a Ratio of 100:0

A porous film was prepared in the same manner as in Example 5, except that the mixing ratio of the small-diameter microbial cellulose nanofibers prepared in Preparation Example 1 and the large-diameter PET fibers prepared in Preparation Example 4 was changed to about 100:0 by weight (no large-diameter fibers were used).

(Manufacture of Lithium Batteries)

### EXAMPLE 8

(Manufacture of Positive Electrode)

LiNi0.6Co_{0.2}Al_{0.2}O₂ as a positive active material, a carbonaceous conducting agent (Denka Black), and polyvinylidene fluoride (PVdF) were mixed together at a weight ratio of 94:3:3 to prepare a mixture. The mixture was mixed with N-methyl pyrrolidone (NMP) in an agate mortar to prepare a positive active material slurry. The positive active material slurry was coated on an aluminum current collector having a thickness of 15 μm to a thickness of about 40 μm using a doctor blade, dried at room temperature, and then further dried in a vacuum at a temperature of 120° C., followed by roll-pressing, thereby manufacturing a positive electrode including a positive active material layer on the current collector.

(Manufacture of Negative Electrode)

Graphite particles having an average particle diameter of 25 μm, a styrene-butadiene rubber (SBR) binder (available from Zeon), and carboxymethyl cellulose (CMC, available from Nippon A&L) were mixed together at a weight ratio of 97:1.5:1.5 to prepare a mixture. Subsequently, distilled water was added to the mixture, and stirred with a mechanical stirrer for about 60 minutes, to thereby prepare a negative active material slurry. The negative active material slurry was coated on a copper current collector having a thickness of 10 μm to a thickness of about 60 μm using a doctor blade, dried at a temperature of 100° C. using a hot-air dryer for about 0.5 hours, and then further dried in a vacuum at a temperature of 120° C. for about 4 hours, followed by roll-pressing, thereby manufacturing a negative electrode including a negative active material layer on the current collector.

(Manufacture of Lithium Battery)

The porous film prepared in Example 1 was used as a separator.

After the porous film of Example 1 was interposed between the positive electrode and the negative electrode and then encased in a pouch, a liquid electrolyte was injected into the pouch and sealed, thereby completing the manufacture of a pouch cell.

The liquid electrolyte used was prepared by dissolving 1.15M LiPF₆ in a mixed solvent of ethylene carbonate (EC), ethylmethyl carbonate (EMC), and dimethyl carbonate (DMC) at a volume ratio of about 2:2:6.

### EXAMPLES 9 to 14

Pouch cells were manufactured in the same manner as in Example 8, except that the porous films prepared in Examples 2 to 7 were used, respectively, as a separator, instead of the porous film of Example 1.

### COMPARATIVE EXAMPLES 8 to 14

Pouch cells were manufactured in the same manner as in Example 8, except that the porous films prepared in Comparative Examples 1 to 7 were used, respectively, as a separator, instead of the porous film of Example 1.

### EVALUATION EXAMPLE 1

### Measurement of Tensile Characteristics of Porous Film

Tensile moduli and tensile strengths (stress at rupture) were measured for samples (having an area of 15 mm×50 mm) of the porous films prepared in Examples 1 to 7 and Comparative Examples 1 to 10, based on a stress-strain curve obtained by stretching each of the samples at a rate of 5 mm/min using a texture analyzer (TA.XT plus, Stable Micro Systems). Some of the measurement results are shown in Table 1.

### EVALUATION EXAMPLE 2

### Measurement of Pin-Puncture Strength of Porous Film

A pin-puncture strength, i.e., the piercing strength required for a 1-mm probe to penetrate a sample, was measured for samples (having an area of 15 mm×50 mm) of the porous films prepared in Examples 1 to 7 and Comparative Examples 1 to 10, using an NDGS puncture strength tester (Kato Tech), wherein force was applied with the 1-mm probe downward to each of the samples placed over a 10-cm hole. Some of the measurement results are shown in Table 1.

TABLE 1

| | Tensile strength | Pin-puncture strength |
|---|---|---|
| Example | [kgf/cm²] | [kgf] |
| Example 1 | 984 | 142 |
| Example 2 | 761 | 117 |
| Example 3 | 573 | 101 |
| Example 4 | 520.8 | 75 |
| Example 5 | 763.1 | 135 |
| Example 6 | 596 | 105 |
| Comparative Example 2 | 450 | 61 |
| Comparative Example 3 | 374 | 46 |

In Table, 1, the tensile strengths and pin-puncture strengths of the porous films of Examples 1 to about 6 and Comparative Examples 2 to 3 are represented.

Referring to Table 1, the porous films of Examples 1 to 6 were found to have a tensile strength of about 500 kgf/cm² or greater and a pin-puncture strength of about 70 kgf or greater, whereas the porous films of Comparative Examples 2 to 3 had a tensile strength of less than 500 kgf/cm² and a pin-puncture strength of less than 70 kgf.

### EVALUATION EXAMPLE 3

### Measurement of Thickness and Gurley Value of Porous Film

Thicknesses and Gurley values (air permeabilities) were measured for samples (having an area of 50 mm×50 mm) of the porous films prepared in Examples 1 to 7 and Comparative Examples 1 to 10.

The thickness of each porous film sample (having an area of 50 mm×50 mm) was measured as an average of the measurement values at 5 point spots of the separator sample, using a thickness indicator TM600 (available from Kumagai Riki Kogyo Co., Ltd.).

The Gurley value, i.e., air permeability of each porous film sample was measured using a permeability tester (EGO-1-55-1MR, Oken Type Air Permeability Tester, E-Globaledge Corporation) by a method in accordance with JIS P8117. A Gurley value is the time it takes for 100 cc of air to permeate a porous film. A Gurley value per unit thickness was calculated by dividing the measured Gurley value by the thickness of each porous film. The higher the air permeability of a porous film, the smaller the Gurley value.

Some of the measurement results are shown in Table 2.

TABLE 2

| | | Gurley value per unit |
|---|---|---|
| | Thickness | thickness |
| Example | [μm] | [sec/100 cc · μm] |
| Example 1 | 15 | 20.1 |
| Example 2 | 15 | 15.4 |
| Example 3 | 16 | 13.4 |
| Example 4 | 15 | 9.5 |
| Example 5 | 16 | 17.2 |
| Example 6 | 15 | 12.5 |
| Example 7 | 16 | 7.5 |
| Comparative Example 1 | 13 | 34.4 |
| Comparative Example 2 | 16 | 6.1 |
| Comparative Example 3 | 16 | 3.1 |
| Comparative Example 4 | 13 | 30.5 |
| Comparative Example 5 | 14 | 31.2 |
| Comparative Example 6 | 14 | 28.5 |
| Comparative Example 7 | 14 | 37.5 |

In Table 2, the thicknesses and the Gurley values of the porous films of Examples 1 to 7 and Comparative Examples 1 to 7 are represented.

Referring to Table 2, the porous films of Examples 1 to 7 were found to have a Gurley value per unit thickness of about 30 sec/100 cc μm or less, whereas the porous films of Comparative Examples 1 and 7 had a Gurley value per unit area of greater than 30 sec/100 cc μm.

The porous films of Comparative Examples 4 to 6, which only included small-diameter fibers having an average diameter of 50 nm or less, were found to provide an insignificant in reduction of Gurley value per unit thickness. Further, although the porous films of Comparative Examples 2 to 3 show significant reduction in Gurley value per unit thickness, these porous films have poor mechanical properties as disclosed in Table 1.

### EVALUATION EXAMPLE 4

### Charge and Discharge Characteristics Evaluation

The lithium batteries (pouch cells) manufactured in Example 10 and Comparative Example 8 were charged with a constant current of 0.1 C at 25° C. until a voltage of 4.2 V (with respect to Li) was reached, and charged with a constant voltage of 4.2 V until a current of 0.01 C was reached. After completion of the charging process, the lithium batteries were rested for 10 minutes and then discharged with a constant current of 0.1 C until a voltage of 2.8 V (vs. Li) was reached (1^{st} cycle).

The batteries were then charged with a constant current of 0.2 C until a voltage of 4.2 V (with respect to Li) was reached, and charged with a constant voltage of 4.2 V until a current of 0.01 C was reached. After completing the charging process, the pouch cells were rested for 10 minutes and then discharged with a constant current of 0.2 C until a voltage of 2.8 V (with respect to Li) was reached (2^{nd} cycle) (The 1^{st} and 2^{nd} cycles correspond to a formation process).

After the formation process, the pouch cells were then charged with a constant current of 1.0 C rate at a temperature of 25° C. until a voltage of 4.2 V (with respect to Li) was reached, and charged with a constant voltage of 4.2 V until a current of 0.01 C was reached. After completion of the charging process, the pouch cells were rested for 10 minutes and then discharged with a constant current of 0.2 C until a voltage of 2.8 V (with respect to Li) was reached (0.2 C cycle).

Subsequently, the pouch cells were then charged with a constant current of 1.0 C rate at a temperature of 25° C. until a voltage of 4.2 V (with respect to Li) was reached, and charged with a constant voltage of 4.2 V until a current of 0.01 C was reached. After completion of the charging process, the pouch cells were rested for 10 minutes and then discharged with a constant current of 3.0 C until a voltage of 2.8 V (with respect to Li) was reached (3.0C cycle).

The charge and discharge test results are shown in Table 3.

High-rate characteristics of the lithium batteries were calculated using Equation 1.

<Equation 1>

3.0C/0.2C capacity retention [%]=[Discharge capacity at 3.0C cycle/Discharge capacity at 0.2C cycle]×100 <Equation 1>

TABLE 3

| | 3.0 C/0.2 C capacity |
|---|---|
| Example | retention [%] |
| Example 10 (BCNF:PCNF = 50:50) | 76.2 |
| Comparative Example 8 | 72.6 |
| (BCNF:PCNF = 100:0) | |

Referring to Table 3, the lithium battery of Example 10 was found to have remarkably improved high-rate characteristics, compared to the lithium battery of Comparative Example 8.

That is, the lithium battery of Example 10 using the porous film including both of the large-diameter fibers and the small-diameter fibers was found to have improved output characteristics, due to suppressed reduction of discharge capacity even with the flow of excess current, compared to the lithium battery of Comparative Example 8 using the porous film including only the small-diameter fibers.

### EVALUATION EXAMPLE 5

### Measurement of Presence of Carboxyl Group

An infrared (IR) spectrum of the cellulose nanofibers prepared in Preparation Example 1 was measured to evaluate whether or not carboxyl groups were included in the cellulose nanofibers.

The cellulose nanofibers of Preparation Example 1 were found to exhibit a peak at around 1,572 cm⁻¹ corresponding to a carboxyl group, and thus include carboxyl groups.

### EVALUATION EXAMPLE 6

### Measurement of Content of Carboxyl Group

The content of carboxyl groups in the cellulose nanofibers of Preparation Example 1 was measured. The results are shown in Table 4. The content of carboxyl groups may be measured by any one of an electric conductivity titration method and an ion chromatography method. In this example, the two methods were used in combination to increase evaluation accuracy.

1. Electric Conductivity Titration Method

The content of carboxyl groups was measured by using electric conductivity titration (Metrohm). 0.05 g of the freeze-dried cellulose nanofibers (CNF) of Preparation Example 1, 27 mL of distilled water, and 3 mL of 0.01M NaCl were added to a 100 mL-beaker, and a pH of the mixture was adjusted with a 0.1M HCL to 3 or lower. Subsequently, 0.04 M of NaOH solution was dropwise added by 0.2 mL each time to the beaker until a pH of 10.5 was reached. The content of carboxyl groups was calculated using Equation 2, based on curves of conductivity and pH. The results are shown in Table 4.

<Equation 2>

Content of carboxyl groups (mmol/g)=[0.04 M×Volume of dropwise added NaOH (mL)]/0.05 g <Equation 2>

2. Ion Chromatography

5 mL of 12 mM HCl was added to 0.015 g of the freeze-dried cellulose nanofibers (CNFs) of Preparation Example 1, and the mixed solution was sonicated for 1 hour. After the resulting solution was left at room temperature for 15 hours, the amount of Na+ was analyzed by ion chromatography, and the content of carboxyl groups was calculated from the amount of Na+.

<Equation 3>

Content of carboxyl groups (mmol/g)=[mmol of Na⁺]/0.015 g <Equation 1>

### EVALUATION EXAMPLE 7

### Measurement of Average Diameter of Cellulose Nanofibers

An appropriately diluted solution of the cellulose nanofibers of Preparation Example 1 were analyzed using a transmission electron microscope (TEM, Super TEM, available from Titan Cubed). Several TEM images were obtained and analyzed using an image analyzer to obtain diameters and lengths of 100 cellulose nanofibers and calculate an average diameter and an average length of the cellulose nanofibers. The full width at half maximum (FWHM) of the average diameter was calculated from a diameter distribution curve of the number of cellulose nanofibers with respect to diameters of the 100 cellulose nanofibers. The results are shown in Table 4.

Average diameters of the cellulose nanofibers of Comparative Preparation Examples 1 to 3 were also calculated using the same method.

### EVALUATION EXAMPLE 8

### Measurement of Weight-Average Degree of Polymerization of Cellulose Nanofibers

The degree of polymerization (DP) of the cellulose nanofibers of Preparation Example 1 was calculated as a degree of polymerization determined by viscosity measurement (DPv) and a weight-average degree of polymerization (DPw).

5 mg of the freeze-dried cellulose nanofibers, 10 mL of pyridine, and 1 mL of phenyl isocyanate were added to a 12 mL-vial, and then subjected to derivatization at about 100° C. for about 48 hours. After 2 mL of methanol was added to the reaction product, the reaction product was washed with 100 mL of 70% methanol twice and then with 50 mL of H₂O twice. Then, the resulting product was analyzed using gel permeation chromatography (GPC) to obtain a molecular weight, molecular weight distribution, and length distribution of the cellulose nanofibers. The GPC was performed using a Waters 2414 refractive index detector and a Waters Alliance e2695 separation module (available from Milford, Mass., USA) equipped with 3 columns, i.e., Styragel HR2, HR4, and HMW7, and using chloroform as an eluent at a flow rate of 1.0 mL/min, wherein a concentration of the sample was 1 mg/mL, an injection volume was 20 microliters (pL), and polystyrene standards (PS, #140) were used as a reference. The results are shown in Table 4.

TABLE 4

| | | | | Weight-average |
|---|---|---|---|---|
| | Content of | Average | | degree of |
| | carboxyl group | diameter | FWHM | polymerization |
| | [mmol/g] | [nm] | [nm] | [DPw] |
| Preparation | 0.11 | 18 | 23 | 5531 |
| Example 1 | | | | |

Referring to Table 4, the cellulose nanofibers of Preparation Example 1 were found to include carboxyl groups.

As described above, according to the one or more embodiments, mechanical characteristics and air permeability of a porous film may be improved by the inclusion of both large-diameter fibers and small-diameter fibers. A lithium battery using a separator including the porous film may have improved energy density and output characteristics.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of the disclosure (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosed subject matter and does not pose a limitation on the scope of the disclosure unless otherwise claimed. No language in the specification should be construed as indicating any non-claimed element as essential to the practice of the subject matter disclosed herein.

Embodiments are described herein, including the best mode of operation. Variations of those embodiments may become apparent to those of ordinary skill in the art upon reading the foregoing description, and such variations are contemplated by applicant. Accordingly, disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A porous film comprising:
small-diameter fibers having an average diameter of about 50 nm or less; and
large-diameter fibers having an average diameter of about 100 nm or greater,
wherein the amount of the large-diameter fibers is about 5 wt % to about 60 wt % based on the total weight of the small-diameter fibers and the large-diameter fibers,
wherein at least one of the small diameter fibers and large diameter fibers comprises cellulose nanofibers.

2. The porous film of claim 1, wherein the porous film has a Gurley value per unit thickness of about 30 sec/100 cc μm or less.

3. The porous film of claim 1, wherein the porous film has a thickness of about 10 μm or greater.

4. The porous film of claim 1, wherein the porous film has a tensile strength of about 500 kgf/cm² or greater.

5. The porous film of claim 1, wherein the porous film has a pin-puncture strength of about 70 kgf/cm² or greater.

6. The porous film of claim 1, wherein the large-diameter fibers comprise at least one selected from cellulose fibers and heat-resistant polymer fibers.

7. The porous film of claim 6, wherein the large-diameter fibers comprise cellulose fibers and comprise at least one selected from plant cellulose fibers, animal cellulose fibers, and microbial cellulose fibers.

8. The porous film of claim 6, wherein the large-diameter fibers comprise heat-resistant polymer fibers, which comprise at least one selected from a polysulfone (PSF) polymer, a polyethersulfone (PES) polymer, a polyetherimide (PEI) polymer, a polyphenylene sulfide (PPS) polymer, a polyetheretherketone (PEEK) polymer, a polyarylate (PA) polymer, a polyamide-imide (PAI) polymer, a polyimide (PI) polymer, a polyamide polymer, and an aramid polymer.

9. The porous film of claim 6, wherein the large-diameter fibers comprise at least one selected from cellulose fibers, polyethylene terephthalate (PET) fibers, polyacrylonitrile (PAN) fibers, polyvinylidene fluoride (PVDF) fibers, nylon fibers, and aramid fibers.

10. The porous film of claim 1, wherein the small-diameter fibers comprise cellulose fibers.

11. The porous film of claim 10, wherein the small-diameter fibers comprise carboxyl group-containing cellulose nanofibers.

12. The porous film of claim 11, wherein a content of carboxyl groups of the carboxyl group-containing cellulose nanofibers is about 0.06 mmol/g or greater.

13. The porous film of claim 11, wherein the carboxyl group-containing cellulose nanofibers are microbial cellulose nanofibers.

14. The porous film of claim 1, wherein the porous film has:
(a) a single-layer structure, wherein the single layer comprises the small-diameter fibers and the large-diameter fibers;
(b) a multilayer structure comprising a first layer comprising the small-diameter fibers and the large-diameter fibers; and a second layer comprising polyolefin disposed on a surface of the first layer;
(c) a multilayer structure comprising a first layer comprising the small-diameter fibers and the large-diameter fibers; and a second layer deposited on a surface of the first layer, the second layer comprising additional small-diameter fibers or large-diameter fibers;
(d) a multilayer structure comprising a first layer comprising the small-diameter fibers and the large-diameter fibers; and second and third layers on opposite surfaces of the first layer, wherein each of the second and third layers comprise additional small-diameter fibers or large-diameter fibers,;
(e) a multilayer structure comprising a first layer comprising the small-diameter fibers and the large-diameter fibers; and second and third layers on opposite surfaces of the first layer, wherein each of the second and third layers comprise additional small-diameter fibers or large-diameter fibers, and the second layer has a composition that is different from that of the third layer;
(f) a multilayer structure comprising a first layer and second and third layers on opposite surfaces of the first layer, wherein the second and third layers comprise the small diameter fibers and the large diameter fibers, and the first layer comprises additional small-diameter fibers or additional large-diameter fibers;
(g) a multilayer structure comprising a first layer on the surface of a second layer and third layer on a surface of the second layer opposite the first layer, wherein the first layer comprises the small-diameter fibers and the large-diameter fibers; the second layer comprises additional small-diameter fibers or additional large-diameter fibers; and the third comprises additional small-diameter fibers or additional large-diameter fibers and has a different composition from the second layer; or
a multilayer structure comprising a first layer on the surface of a second layer and a third layer on a surface of the second layer opposite the first layer, wherein the first layer comprises the small-diameter fibers and the large-diameter fibers; the second layer comprises additional small-diameter fibers or additional large-diameter fibers; and the third layer comprises the small-diameter fibers and the large-diameter fibers and has a different composition from the first layer.

15. A separator comprising the porous film according to claim 1.

16. An electrochemical device comprising:
a positive electrode;
a negative electrode; and
the separator of claim 15 positioned between the positive electrode and the negative electrode.

17. The electrochemical device of claim 16, wherein the electrochemical device is a lithium battery or an electric double-layer capacitor.

18. A method of preparing a porous film of claim 1, the method comprising:
preparing a composition comprising large-diameter fibers having an average diameter of about 100 nm or greater, small-diameter fibers having an average diameter of about 50 nm or less, a hydrophilic pore-forming agent, and a solvent, and applying the composition onto a substrate;
drying the composition to thereby form a sheet on the substrate; and
separating the sheet from the substrate to thereby obtain the sheet as the porous film.

19. The method of claim 18, wherein the hydrophilic pore-forming agent comprises at least one selected from ethylene carbonate, vinylene carbonate, propane sulfone, ethylene sulfate, dimethyl sulfone, ethyl methyl sulfone, dipropyl sulfone, dibutyl sulfone, trimethylene sulfone, tetramethylene sulfone, di(methoxyethyl) sulfone (CH₃OCH₂CH₂)₂SO₂), ethylcyclopentylsulfone (C₂H₅SO₂C₅H₉), 1,5-pentanediol, 1-methylamino-2,3-propanediol, ϵ-caprolactone, γ-butyrolactone, α-acetyl-γ-butyrolactone, diethylene glycol, 1,3-butylene glycol, propylene glycol, triethylene glycol dimethyl ether, tripropylene glycol dimethyl ether, diethylene glycol monobutyl ether, triethylene glycol monomethyl ether, triethylene glycol butyl methyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, diethylene glycol monoisopropyl ether, ethylene glycol monoisobutyl ether, tripropylene glycol monomethyl ether, diethylene glycol methyl ethyl ether, diethylene glycol diethyl ether, polyethylene glycol, glycerin, propylene carbonate, and N-methylpyrrolidone.
